(19) United States
(12) Patent Application Publication
(10) Pub. No.: US 2023/0300878 A1
(43) Pub. Date: Sep. 21, 2023

(54) CONTROL MECHANISMS FOR UPLINK CHANNEL ACCESS TYPES

(71) Applicant: QUALCOMM Incorporated, San Diego, CA (US)

(72) Inventors: Jing Sun, San Diego, CA (US); Vinay CHANDE, San Diego, CA (US)

(21) Appl. No.: 18/166,395

(22) Filed: Feb. 8, 2023

Related U.S. Application Data
(60) Provisional application No. 63/321,548, filed on Mar. 18, 2022.

(51) Int. Cl. H04W 74/00; H04W 74/08

(52) U.S. Cl. CPC H04W 74/006; H04W 74/0808

(57) ABSTRACT

Methods, systems, and devices for wireless communications are described. In some aspects, a user equipment (UE) and a network entity may support a control mechanism according to which the UE determines whether an upgrade from a first channel access type to a second channel access type is available for an uplink transmission from the UE to the network entity. For example, the network entity may configure the UE with a set of channel access types and the UE may determine whether the second channel access type is available for the uplink transmission based on which channel access types are present in the set of channel access types. As such, the UE may upgrade from the first channel access type to the second channel access type if the second channel access type is present in the set of channel access types.

### CROSS REFERENCE

The present application for patent claims the benefit of U.S. Provisional Patent Application No. 63/321,548 by SUN et al., entitled “CONTROL MECHANISMS FOR UPLINK CHANNEL ACCESS TYPES,” filed Mar. 18, 2022, and assigned to the assignee hereof. U.S. Provisional Patent Application No. 63/321,548 is expressly incorporated by reference herein in its entirety.

### INTRODUCTION

The following relates to wireless communications relating to control mechanisms for uplink channel access types.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support control mechanisms for uplink channel access types. For example, the described techniques support a control mechanism according to which a user equipment (UE) determines whether an upgrade from a first channel access type to a second channel access type is available for an uplink transmission from the UE to a network entity. For example, the network entity may configure the UE with a set of channel access types and the UE may determine whether the second channel access type is available for the uplink transmission based on which channel access types are present in the set of channel access types. As such, the UE may upgrade from the first channel access type to the second channel access type if the second channel access type is present in the set of channel access types.

A method of wireless communication performed by a first network node is described. The method may include receiving, from a second network node, a control message that indicates a set of one or more channel access types that are available to the first network node for communications between the first network node and the second network node, receiving, from the second network node, a first downlink control information (DCI) message that schedules an uplink message from the first network node and indicates, for the uplink message, a first channel access type from the set of one or more channel access types, and transmitting, during a channel occupancy time (COT) of the second network node and based on whether a second channel access type is present in the set of one or more channel access types indicated by the control message, the uplink message in accordance with the second channel access type, where the second channel access type is different from the first channel access type.

A first network node is described. The first network node may include a memory and at least one processor coupled to the memory. The processor may be configured to cause the first network node to receive, from a second network node, a control message that indicates a set of one or more channel access types that are available to the first network node for communications between the first network node and the second network node, receive, from the second network node, a first DCI message that schedules an uplink message from the first network node and indicates, for the uplink message, a first channel access type from the set of one or more channel access types, and transmit, during a COT of the second network node and based on whether a second channel access type is present in the set of one or more channel access types indicated by the control message, the uplink message in accordance with the second channel access type, where the second channel access type is different from the first channel access type.

Another apparatus for wireless communication at a first network node is described. The apparatus may include means for receiving, from a second network node, a control message that indicates a set of one or more channel access types that are available to the first network node for communications between the first network node and the second network node, means for receiving, from the second network node, a first DCI message that schedules an uplink message from the first network node and indicates, for the uplink message, a first channel access type from the set of one or more channel access types, and means for transmitting, during a COT of the second network node and based on whether a second channel access type is present in the set of one or more channel access types indicated by the control message, the uplink message in accordance with the second channel access type, where the second channel access type is different from the first channel access type.

A non-transitory computer-readable medium having code for wireless communication stored thereon that, when executed by a first network node, causes the first network node to receive, from a second network node, a control message that indicates a set of one or more channel access types that are available to the first network node for communications between the first network node and the second network node, receive, from the second network node, a first DCI message that schedules an uplink message from the first network node and indicates, for the uplink message, a first channel access type from the set of one or more channel access types, and transmit, during a COT of the second network node and based on whether a second channel access type is present in the set of one or more channel access types indicated by the control message, the uplink message in accordance with the second channel access type, where the second channel access type is different from the first channel access type.

In some examples of the method, apparatuses, and non-transitory computer-readable medium described herein, the set of one or more channel access types that may be available to the first network node includes the first channel access type and at least one of a first candidate channel access type or a second candidate channel access type and the second channel access type may be one of the first candidate channel access type or the second candidate channel access type.

In some examples of the method, apparatuses, and non-transitory computer-readable medium described herein, transmitting the uplink message in accordance with the second channel access type may include operations, features, means, or instructions for transmitting the uplink message during the COT of the second network node in accordance with the first candidate channel access type based on the first candidate channel access type being present in the set of one or more channel access types or based on the second candidate channel access type being excluded from the set of one or more channel access types.

In some examples of the method, apparatuses, and non-transitory computer-readable medium described herein, transmitting the uplink message in accordance with the second channel access type may include operations, features, means, or instructions for transmitting the uplink message during the COT of the second network node in accordance with the second candidate channel access type based on the second candidate channel access type being present in the set of one or more channel access types or based on the first candidate channel access type being excluded from the set of one or more channel access types.

In some examples of the method, apparatuses, and non-transitory computer-readable medium described herein, the first channel access type includes one or more channel sensing operations associated with a channel sensing count prior to occupation of a channel between the first network node and the second network node, the first candidate channel access type includes a single channel sensing operation prior to occupation of the channel, and the second candidate channel access type excludes channel sensing operations prior to occupation of the channel.

In some examples of the method, apparatuses, and non-transitory computer-readable medium described herein, each respective channel sensing operation may be a respective LBT operation.

In some examples of the method, apparatuses, and non-transitory computer-readable medium described herein, the control message indicates a mapping between each respective permutation of a set of multiple permutations of a set of one or more bits and each respective channel access type of the set of one or more channel access types.

In some examples of the method, apparatuses, and non-transitory computer-readable medium described herein, the first DCI message includes a first permutation of the set of multiple permutations of the set of one or more bits and the first permutation maps to the first channel access type in accordance with the mapping.

In some examples of the method, apparatuses, and non-transitory computer-readable medium described herein, the first DCI message includes a channel access control field including the first permutation.

In some examples of the method, apparatuses, and non-transitory computer-readable medium described herein, the second channel access type may be present in the set of one or more channel access types if at least one permutation of the set of multiple permutations maps to the second channel access type in accordance with the mapping.

In some examples of the method, apparatuses, and non-transitory computer-readable medium described herein, the control message indicates a first mapping between each respective permutation of a set of multiple permutations of a set of one or more bits and each respective channel access type of a first set of one or more channel access types, the control message indicates a second mapping between each respective permutation of the set of multiple permutations of the set of one or more bits and each respective channel access type of a second set of one or more channel access types, and the set of one or more channel access types includes the first set of one or more channel access types and the second set of one or more channel access types.

In some examples of the method, apparatuses, and non-transitory computer-readable medium described herein, the first DCI message includes a first permutation of the set of multiple permutations of the set of one or more bits and the first permutation maps to the first channel access type in accordance with the first mapping.

In some examples of the method, apparatuses, and non-transitory computer-readable medium described herein, the first DCI message includes a channel access control field including the first permutation.

In some examples of the method, apparatuses, and non-transitory computer-readable medium described herein, the first mapping may be associated with DCI messages that schedule uplink communication and the second mapping may be associated with DCI messages that schedule downlink communication.

In some examples of the method, apparatuses, and non-transitory computer-readable medium described herein, the second channel access type may be present in the set of one or more channel access types if at least one permutation of the set of multiple permutations maps to the second channel access type in accordance with the first mapping or the second mapping.

In some examples of the method, apparatuses, and non-transitory computer-readable medium described herein, the second channel access type may be present in the set of one or more channel access types if at least one first permutation of the set of multiple permutations maps to the second channel access type in accordance with the first mapping and at least one second permutation of the set of multiple permutations maps to the second channel access type in accordance with the second mapping.

In some examples of the method, apparatuses, and non-transitory computer-readable medium described herein, the second channel access type may be present in the set of one or more channel access types if at least one permutation of the set of multiple permutations maps to the second channel access type in accordance with the first mapping.

In some examples of the method, apparatuses, and non-transitory computer-readable medium described herein, the second channel access type may be present in the set of one or more channel access types if at least one permutation of the set of multiple permutations maps to the second channel access type in accordance with the second mapping.

Some examples of the method, apparatuses, and non-transitory computer-readable medium described herein may further include operations, features, means, or instructions for receiving, from the second network node, a second DCI message that indicates a slot format, where the slot format indicates the COT of the second network node, and where the uplink message may be transmitted in accordance with the second channel access type based on the slot format.

In some examples of the method, apparatuses, and non-transitory computer-readable medium described herein, the slot format indicates a starting time and a duration of the COT of the second network node.

In some examples of the method, apparatuses, and non-transitory computer-readable medium described herein, the control message that indicates the set of one or more channel access types enables or disables an upgrade, for the uplink message, from the first channel access type to the second channel access type during the COT of the second network node based on whether the second channel access type may be present in the set of one or more channel access types.

In some examples of the method, apparatuses, and non-transitory computer-readable medium described herein, a presence of the second channel access type in the set of one or more channel access types may be based on a geographic location of the first network node.

A method of wireless communication performed by first network node is described. The method may include receiving, from a second network node, a control message that indicates a set of one or more channel access types that are available to the first network node for communications between the first network node and the second network node, transmitting, during a COT obtained via a first channel access type, a first uplink message within a threshold COT associated with the first uplink message, where the COT is released after the first uplink message, and transmitting, during a resumption of the COT and based on whether a second channel access type is present in the set of one or more channel access types, a second uplink message in accordance with the second channel access type, where the second channel access type is different from the first channel access type.

A first network node is described. The first network node may include a memory and at least one processor coupled to the memory. The processor may be configured to cause the first network node to receive, from a second network node, a control message that indicates a set of one or more channel access types that are available to the first network node for communications between the first network node and the second network node, transmit, during a COT obtained via a first channel access type, a first uplink message within a threshold COT associated with the first uplink message, where the COT is released after the first uplink message, and transmit, during a resumption of the COT and based on whether a second channel access type is present in the set of one or more channel access types, a second uplink message in accordance with the second channel access type, where the second channel access type is different from the first channel access type.

Another apparatus for wireless communication at first network node is described. The apparatus may include means for receiving, from a second network node, a control message that indicates a set of one or more channel access types that are available to the first network node for communications between the first network node and the second network node, means for transmitting, during a COT obtained via a first channel access type, a first uplink message within a threshold COT associated with the first uplink message, where the COT is released after the first uplink message, and means for transmitting, during a resumption of the COT and based on whether a second channel access type is present in the set of one or more channel access types, a second uplink message in accordance with the second channel access type, where the second channel access type is different from the first channel access type.

A non-transitory computer-readable medium having code for wireless communication stored thereon that, when executed by a first network node, causes the first network node to receive, from a second network node, a control message that indicates a set of one or more channel access types that are available to the first network node for communications between the first network node and the second network node, transmit, during a COT obtained via a first channel access type, a first uplink message within a threshold COT associated with the first uplink message, where the COT is released after the first uplink message, and transmit, during a resumption of the COT and based on whether a second channel access type is present in the set of one or more channel access types, a second uplink message in accordance with the second channel access type, where the second channel access type is different from the first channel access type.

In some examples of the method, apparatuses, and non-transitory computer-readable medium described herein, the set of one or more channel access types that may be available to the first network node includes the first channel access type and at least one of a first candidate channel access type or a second candidate channel access type and the second channel access type may be one of the first candidate channel access type or the second candidate channel access type.

In some examples of the method, apparatuses, and non-transitory computer-readable medium described herein, transmitting the second uplink message in accordance with the second channel access type may include operations, features, means, or instructions for transmitting the second uplink message during the resumption of the COT in accordance with the first candidate channel access type based on the first candidate channel access type being present in the set of one or more channel access types or based on the second candidate channel access type being excluded from the set of one or more channel access types.

In some examples of the method, apparatuses, and non-transitory computer-readable medium described herein, transmitting the second uplink message in accordance with the second channel access type may include operations, features, means, or instructions for transmitting the second uplink message during the resumption of the COT in accordance with the second candidate channel access type based on the second candidate channel access type being present in the set of one or more channel access types or based on the first candidate channel access type being excluded from the set of one or more channel access types.

In some examples of the method, apparatuses, and non-transitory computer-readable medium described herein, the first channel access type includes one or more channel sensing operations associated with a channel sensing count prior to occupation of a channel between the first network node and the second network node, the first candidate channel access type includes a single channel sensing operation prior to occupation of the channel, and the second candidate channel access type excludes channel sensing operations prior to occupation of the channel.

In some examples of the method, apparatuses, and non-transitory computer-readable medium described herein, each respective channel sensing operation may be a respective listen-before-talk operation.

In some examples of the method, apparatuses, and non-transitory computer-readable medium described herein, the control message indicates a mapping between each respective permutation of a set of multiple permutations of a set of one or more bits and each respective channel access type of the set of one or more channel access types.

In some examples of the method, apparatuses, and non-transitory computer-readable medium described herein, a DCI message that schedules the first uplink message includes a first permutation of the set of multiple permutations of the set of one or more bits and the first permutation maps to the first channel access type in accordance with the mapping.

In some examples of the method, apparatuses, and non-transitory computer-readable medium described herein, the DCI message includes a channel access control field including the first permutation.

In some examples of the method, apparatuses, and non-transitory computer-readable medium described herein, the second channel access type may be present in the set of one or more channel access types if at least one permutation of the set of multiple permutations maps to the second channel access type in accordance with the mapping.

In some examples of the method, apparatuses, and non-transitory computer-readable medium described herein, the control message indicates a first mapping between each respective permutation of a set of multiple permutations of a set of one or more bits and each respective channel access type of a first set of one or more channel access types, the control message indicates a second mapping between each respective permutation of the set of multiple permutations of the set of one or more bits and each respective channel access type of a second set of one or more channel access types, and the set of one or more channel access types includes the first set of one or more channel access types and the second set of one or more channel access types.

In some examples of the method, apparatuses, and non-transitory computer-readable medium described herein, a DCI message that schedules the first uplink message includes a first permutation of the set of multiple permutations of the set of one or more bits and the first permutation maps to the first channel access type in accordance with the first mapping.

In some examples of the method, apparatuses, and non-transitory computer-readable medium described herein, the DCI message includes a channel access control field including the first permutation.

In some examples of the method, apparatuses, and non-transitory computer-readable medium described herein, the first mapping may be associated with DCI messages that schedule uplink communication and the second mapping may be associated with DCI messages that schedule downlink communication.

In some examples of the method, apparatuses, and non-transitory computer-readable medium described herein, the second channel access type may be present in the set of one or more channel access types if at least one permutation of the set of multiple permutations maps to the second channel access type in accordance with the first mapping or the second mapping.

In some examples of the method, apparatuses, and non-transitory computer-readable medium described herein, the second channel access type may be present in the set of one or more channel access types if at least one first permutation of the set of multiple permutations maps to the second channel access type in accordance with the first mapping and at least one second permutation of the set of multiple permutations maps to the second channel access type in accordance with the second mapping.

In some examples of the method, apparatuses, and non-transitory computer-readable medium described herein, the second channel access type may be present in the set of one or more channel access types if at least one permutation of the set of multiple permutations maps to the second channel access type in accordance with the first mapping.

In some examples of the method, apparatuses, and non-transitory computer-readable medium described herein, the second channel access type may be present in the set of one or more channel access types if at least one permutation of the set of multiple permutations maps to the second channel access type in accordance with the second mapping.

Some examples of the method, apparatuses, and non-transitory computer-readable medium described herein may further include operations, features, means, or instructions for resuming the COT for the second uplink message in accordance with the second channel access type based on whether the second channel access type may be present in the set of one or more channel access types, where the second uplink message may be transmitted based on the resumption of the COT in accordance with the second channel access type.

In some examples of the method, apparatuses, and non-transitory computer-readable medium described herein, the control message that indicates the set of one or more channel access types enables or disables an upgrade, for the second uplink message, from the first channel access type to the second channel access type during the resumption of the COT based on whether the second channel access type may be present in the set of one or more channel access types.

In some examples of the method, apparatuses, and non-transitory computer-readable medium described herein, a presence of the second channel access type in the set of one or more channel access types may be based on a geographic location of the first network node.

A method of wireless communication performed by a first network node is described. The method may include receiving, from a second network node, a first broadcast DCI message that schedules a set of resources for reception of system information and that indicates a first channel access type for a first random access message and transmitting, to the second network node, the first random access message in accordance with a channel access procedure that is based on the first channel access type indicated by the first broadcast DCI message.

A first network node is described. The first network node may include a memory and at least one processor coupled to the memory. The processor may be configured to cause the first network node to receive, from a second network node, a first broadcast DCI message that schedules a set of resources for reception of system information and that indicates a first channel access type for a first random access message and transmit, to the second network node, the first random access message in accordance with a channel access procedure that is based on the first channel access type indicated by the first broadcast DCI message.

Another apparatus for wireless communication at a first network node is described. The apparatus may include means for receiving, from a second network node, a first broadcast DCI message that schedules a set of resources for reception of system information and that indicates a first channel access type for a first random access message and means for transmitting, to the second network node, the first random access message in accordance with a channel access procedure that is based on the first channel access type indicated by the first broadcast DCI message.

A non-transitory computer-readable medium having code for wireless communication stored thereon that, when executed by a first network node, causes the first network node to receive, from a second network node, a first broadcast DCI message that schedules a set of resources for reception of system information and that indicates a first channel access type for a first random access message and transmit, to the second network node, the first random access message in accordance with a channel access procedure that is based on the first channel access type indicated by the first broadcast DCI message.

Some examples of the method, apparatuses, and non-transitory computer-readable medium described herein may further include operations, features, means, or instructions for receiving information indicative of the first channel access type via a channel access control field of the first broadcast DCI message.

In some examples of the method, apparatuses, and non-transitory computer-readable medium described herein, the first channel access type indicates that the first network node may be to skip a listen-before-talk procedure for the first random access message or that the first network node may be to perform the listen-before-talk procedure for the first random access message.

In some examples of the method, apparatuses, and non-transitory computer-readable medium described herein, the first channel access type indicates one of a first candidate channel access type or a second candidate channel access type, the first candidate channel access type includes one or more channel sensing operations during a pendency of a countdown timer prior to occupation of a channel between the first network node and the second network node, and the second candidate channel access type excludes channel sensing operations prior to occupation of a channel between the first network node and the second network node.

In some examples of the method, apparatuses, and non-transitory computer-readable medium described herein, transmitting the first random access message may include operations, features, means, or instructions for transmitting the first random access message via contention-based signaling if the first network node may be to use the first candidate channel access type for the first random access message and transmitting the first random access message via contention-exempt signaling if the first network node may be to use the second candidate channel access type for the first random access message.

Some examples of the method, apparatuses, and non-transitory computer-readable medium described herein may further include operations, features, means, or instructions for decoding the first broadcast DCI message based on a system information radio network identifier.

Some examples of the method, apparatuses, and non-transitory computer-readable medium described herein may further include operations, features, means, or instructions for receiving a second broadcast DCI that indicates a second channel access type for the first random access message, where the second channel access type may be different from the first channel access type and ignoring the second channel access type for the first random access message in accordance with a configured rule.

In some examples of the method, apparatuses, and non-transitory computer-readable medium described herein, the configured rule indicates that the second channel access type may be to be ignored if the first channel access type may be indicated for the first random access message.

In some examples of the method, apparatuses, and non-transitory computer-readable medium described herein, the configured rule indicates that the second channel access type may be to be ignored if the first channel access type includes one or more channel sensing operations associated with a channel sensing count prior to occupation of a channel between the first network node and the second network node.

In some examples of the method, apparatuses, and non-transitory computer-readable medium described herein, the configured rule indicates that the second channel access type may be to be ignored if the first channel access type excludes channel sensing operations prior to occupation of a channel between the first network node and the second network node.

In some examples of the method, apparatuses, and non-transitory computer-readable medium described herein, the first broadcast DCI message that indicates the first channel access type for the first random access message enables or disables an upgrade, for the first random access message, from contention-based signaling to contention-exempt signaling based on the first channel access type.

Some examples of the method, apparatuses, and non-transitory computer-readable medium described herein may further include operations, features, means, or instructions for receive, from the second network node, a second random access message responsive to the first random access message and establish a connection between the first network node and the second network node based on the first random access message and the second random access message.

In some examples of the method, apparatuses, and non-transitory computer-readable medium described herein, the first channel access type may be based on a geographic location of the first network node.

A method of wireless communication performed by a first network node is described. The method may include transmitting, to a second network node, a first broadcast DCI message that schedules a set of resources for transmission of system information and that indicates a first channel access type for a first random access message and receiving, from the second network node, the first random access message in accordance with a channel access procedure that is based on the first channel access type indicated by the first broadcast DCI message.

A first network node is described. The first network node may include a memory and at least one processor coupled to the memory. The processor may be configured to cause the first network node to transmit, to a second network node, a first broadcast DCI message that schedules a set of resources for transmission of system information and that indicates a first channel access type for a first random access message and receive, from the second network node, the first random access message in accordance with a channel access procedure that is based on the first channel access type indicated by the first broadcast DCI message.

Another apparatus for wireless communication at a first network node is described. The apparatus may include means for transmitting, to a second network node, a first broadcast DCI message that schedules a set of resources for transmission of system information and that indicates a first channel access type for a first random access message and means for receiving, from the second network node, the first random access message in accordance with a channel access procedure that is based on the first channel access type indicated by the first broadcast DCI message.

A non-transitory computer-readable medium having code for wireless communication stored thereon that, when executed by a first network node, causes the first network node to transmit, to a second network node, a first broadcast DCI message that schedules a set of resources for transmission of system information and that indicates a first channel access type for a first random access message and receive, from the second network node, the first random access message in accordance with a channel access procedure that is based on the first channel access type indicated by the first broadcast DCI message.

Some examples of the method, apparatuses, and non-transitory computer-readable medium described herein may further include operations, features, means, or instructions for transmitting information indicative of the first channel access type via a channel access control field of the first broadcast DCI message.

In some examples of the method, apparatuses, and non-transitory computer-readable medium described herein, the first channel access type indicates that the second network node may be to skip a listen-before-talk procedure for the first random access message or that the second network node may be to perform the listen-before-talk procedure for the first random access message.

In some examples of the method, apparatuses, and non-transitory computer-readable medium described herein, the first channel access type indicates one of a first candidate channel access type or a second candidate channel access type, the first candidate channel access type includes one or more channel sensing operations during a pendency of a countdown timer prior to occupation of a channel between the first network node and the second network node, and the second candidate channel access type excludes channel sensing operations prior to occupation of a channel between the first network node and the second network node.

In some examples of the method, apparatuses, and non-transitory computer-readable medium described herein, receiving the first random access message may include operations, features, means, or instructions for receiving the first random access message via contention-based signaling if the second network node may be to use the first candidate channel access type for the first random access message and receiving the first random access message via contention-exempt signaling if the second network node may be to use the second candidate channel access type for the first random access message.

Some examples of the method, apparatuses, and non-transitory computer-readable medium described herein may further include operations, features, means, or instructions for scrambling the first broadcast DCI message based on a system information radio network identifier.

Some examples of the method, apparatuses, and non-transitory computer-readable medium described herein may further include operations, features, means, or instructions for transmitting a second broadcast DCI that indicates a second channel access type for the first random access message, where the second channel access type may be different from the first channel access type and ignoring the second channel access type for the first random access message in accordance with a configured rule.

In some examples of the method, apparatuses, and non-transitory computer-readable medium described herein, the configured rule indicates that the second channel access type may be to be ignored if the first channel access type may be indicated for the first random access message.

In some examples of the method, apparatuses, and non-transitory computer-readable medium described herein, the configured rule indicates that the second channel access type may be to be ignored if the first channel access type includes one or more channel sensing operations associated with a channel sensing count prior to occupation of a channel between the first network node and the second network node.

In some examples of the method, apparatuses, and non-transitory computer-readable medium described herein, the configured rule indicates that the second channel access type may be to be ignored if the first channel access type excludes channel sensing operations prior to occupation of a channel between the first network node and the second network node.

In some examples of the method, apparatuses, and non-transitory computer-readable medium described herein, the first broadcast DCI message that indicates the first channel access type for the first random access message enables or disables an upgrade, for the first random access message, from contention-based signaling to contention-exempt signaling based on the first channel access type.

Some examples of the method, apparatuses, and non-transitory computer-readable medium described herein may further include operations, features, means, or instructions for transmitting, to the second network node, a second random access message responsive to the first random access message and establishing a connection between the first network node and the second network node based on the first random access message and the second random access message.

In some examples of the method, apparatuses, and non-transitory computer-readable medium described herein, the first channel access type may be based on a geographic location of the first network node.

### BRIEF DESCRIPTION OF THE DRAWINGS

FIG. 1 illustrates an example of a wireless communications systems that supports control mechanisms for uplink channel access types in accordance with one or more aspects of the present disclosure.

FIGS. 2A and 2B illustrate examples of wireless communications systems that support control mechanisms for uplink channel access types in accordance with one or more aspects of the present disclosure.

FIGS. 3 and 4 illustrate examples of communication timelines that support control mechanisms for uplink channel access types in accordance with one or more aspects of the present disclosure.

FIGS. 5 through 7 illustrate examples of process flows that support control mechanisms for uplink channel access types in accordance with one or more aspects of the present disclosure.

FIGS. 8 and 9 show block diagrams of devices that support control mechanisms for uplink channel access types in accordance with one or more aspects of the present disclosure.

FIG. 10 shows a block diagram of a communications manager that supports control mechanisms for uplink channel access types in accordance with one or more aspects of the present disclosure.

FIG. 11 shows a diagram of a system including a device that supports control mechanisms for uplink channel access types in accordance with one or more aspects of the present disclosure.

FIGS. 12 and 13 show block diagrams of devices that support control mechanisms for uplink channel access types in accordance with one or more aspects of the present disclosure.

FIG. 14 shows a block diagram of a communications manager that supports control mechanisms for uplink channel access types in accordance with one or more aspects of the present disclosure.

FIG. 15 shows a diagram of a system including a device that supports control mechanisms for uplink channel access types in accordance with one or more aspects of the present disclosure.

FIGS. 16 through 19 show flowcharts illustrating methods that support control mechanisms for uplink channel access types in accordance with one or more aspects of the present disclosure.

### DETAILED DESCRIPTION

In some wireless communications systems, a user equipment (UE) may communicate with a network entity on an unlicensed radio frequency band. In such systems, the UE may contend for access to a channel between the UE and the network entity in accordance with one of various channel access procedures. For example, the UE may use a Type 1 channel access procedure, a Type 2 channel access procedure, or a Type 3 channel access procedure to occupy the channel between the UE and the network entity, and such channel access procedures may involve different levels of channel sensing (e.g., a Type 2 channel access procedure may involve less channel sensing than a Type 1 channel access procedure and a Type 3 channel access procedure may involve no channel sensing).

In some deployment scenarios, the UE may support various features relating to an upgrade, for a given uplink transmission, from a Type 1 channel access procedure (which may involve relatively more channel sensing and, likewise, a relatively greater processing cost at the UE) to a Type 2 or a Type 3 channel access procedure (which may involve relatively less channel sensing and, likewise, a relatively lesser processing cost at the UE). Additionally, or alternatively, the UE may support a feature relating to an upgrade, for a random access message (e.g., a message 1 (msg1) or a message A (msgA) transmission) from contention-based signaling to contention-exempt signaling. The UE and the network entity, however, may lack an efficient control mechanism for enabling or disabling such upgrades. For example, an availability or allowability of such upgrades for uplink transmissions and random access messaging from the UE may vary across different scenarios and may depend on a geographic location of the UE, but the UE and the network entity may lack a mutually understood control mechanism that accounts for whether a specific upgrade is available or allowed for the UE.

In some implementations of the present disclosure, the UE and the network entity may support a control mechanism according to which the UE may determine whether an upgrade from a first channel access type to a second channel access type is available for an uplink transmission from the UE to the network entity. For example, the network entity may configure the UE with a set of channel access types and the UE 115 may determine whether the second channel access type is available for the uplink transmission based on which channel access types are present in the set of channel access types. As such, the UE may upgrade from the first channel access type to the second channel access type if the second channel access type is present in the set of channel access types.

For example, in scenarios in which an uplink message is initially scheduled or configured with a Type 1 channel access procedure and in which the uplink message overlaps with a COT of the network entity, the UE may attempt to obtain access to a channel between the UE and the network entity for the uplink message in accordance with a Type 2 or a Type 3 channel access procedure based on whether the network entity configures a Type 2 or a Type 3 channel access procedure as available to the UE via the set of channel access types. Additionally, or alternatively, in scenarios in which the UE initiates a COT for a first uplink message in accordance with a Type 1 channel access procedure and is scheduled or configured to transmit a second uplink message after releasing the COT, the UE may attempt to resume the COT in accordance with a Type 2 or a Type 3 channel access procedure based on whether the network entity configures a Type 2 or a Type 3 channel access procedure as available to the UE via the set of channel access types. Additionally, or alternatively, the UE and the network entity may support a channel access control field in a broadcast downlink control information (DCI) message that schedules system information (e.g., remaining minimum system information (RMSI)) and the network entity may use the channel access control field in the broadcast DCI message to indicate whether the UE is to transmit a msg1 or msgA in accordance with contention-based signaling or in accordance with contention-exempt signaling.

Particular implementations of the subject matter described in this disclosure can be implemented to realize one or more of the following potential advantages. For example, in accordance with supporting such a control mechanism according to which the UE may determine whether an upgrade from a first channel access type to a second channel access type is available for an uplink transmission from the UE to the network entity, the UE may obtain access to a channel with relatively lesser processing costs or lower latency while also adhering to scenario-specific considerations and local regulations (as different geographic locations may have different restrictions on which upgrades are allowed). In implementations in which the UE is able to upgrade from a Type 1 channel access procedure to a Type 2 or a Type 3 channel access procedure for an uplink transmission, the UE may reliably obtain the channel with relatively fewer sensing operations, which may reduce power costs and increase a battery life of the UE. Further, in implementations in which the UE is able to use contention-exempt signaling for a msg1 or msgA transmission, the UE may establish a connection with the network entity with lower latency, which may improve system connectivity. The UE and the network entity may further experience higher reliability, which may support higher data rates, greater system capacity, and greater spectral efficiency, among other benefits, in accordance with the described configuration- (e.g., behavioral-) and signaling-based mechanisms.

Aspects of the disclosure are initially described in the context of wireless communications systems. Aspects of the disclosure are further illustrated by and described with reference to communication timelines and process flows. Aspects of the disclosure are further illustrated by and described with reference to apparatus diagrams, system diagrams, and flowcharts that relate to control mechanisms for uplink channel access types.

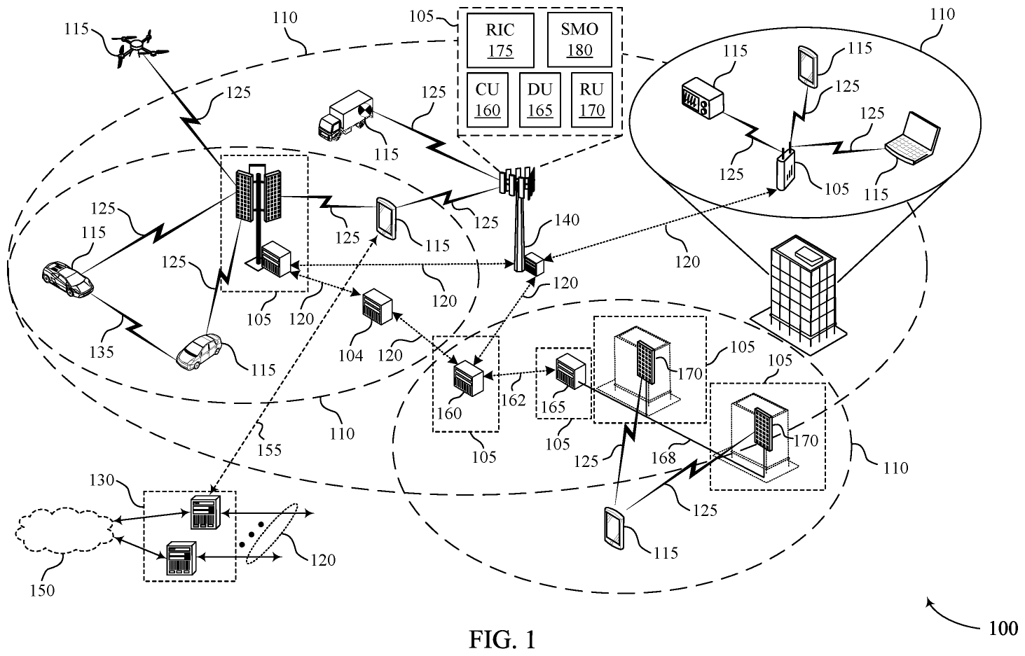

FIG. 1 illustrates an example of a wireless communications system 100 that supports control mechanisms for uplink channel access types in accordance with one or more aspects of the present disclosure. The wireless communications system 100 may include one or more network entities 105, one or more UEs 115, and a core network 130. In some implementations, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some implementations, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node, which may be referred to as a node, a network node, a network entity, or a wireless node, may be a base station (e.g., any base station described herein), a UE (e.g., any UE described herein), a network controller, an apparatus, a device, a computing system, one or more components, and/or another suitable processing entity configured to perform any of the techniques described herein. For example, a network node may be a UE. As another example, a network node may be a base station. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a first one or more components, a first processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

In some implementations, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some implementations, network entities 105 may communicate with one another over a backhaul communication link 120 (e.g., in accordance with an X2, Xn, or other interface protocol) either directly (e.g., directly between network entities 105) or indirectly (e.g., via a core network 130). In some implementations, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some implementations, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some implementations, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (MC) 175 (e.g., a Near-Real Time MC (Near-RT RIC), a Non-Real Time MC (Non-RT RIC)), a Service Management and Orchestration (SMO) 180 system, or any combination thereof. An RU 170 also may be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some implementations, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some implementations, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some implementations, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some implementations, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some implementations, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some implementations, the IAB nodes 104 may include DUs 165 that support communication links with additional entities (e.g., IAB nodes 104, UEs 115) within the relay chain or configuration of the access network (e.g., downstream). In such implementations, one or more components of the disaggregated RAN architecture (e.g., one or more IAB nodes 104 or components of IAB nodes 104) may be configured to operate according to the techniques described herein.

In the implementation of the techniques described herein applied in the context of a disaggregated RAN architecture, one or more components of the disaggregated RAN architecture may be configured to support control mechanisms for uplink channel access types as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” also may be referred to as a unit, a station, a terminal, or a client, among other examples. A UE 115 also may include or may be referred to as a personal electronic device such as a cellular phone, a personal digital assistant (PDA), a tablet computer, a laptop computer, or a personal computer. In some implementations, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which implementation the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some implementations, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some implementations, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some implementations, a network entity 105 (e.g., a base station 140, an RU 170) may be movable and therefore provide communication coverage for a moving coverage area 110. In some implementations, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some implementations, a UE 115 may be able to communicate directly with other UEs 115 over a device-to-device (D2D) communication link 135 (e.g., in accordance with a peer-to-peer (P2P), D2D, or sidelink protocol). In some implementations, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some implementations, one or more UEs 115 in such a group may be outside the coverage area 110 of a network entity 105 or may be otherwise unable to or not configured to receive transmissions from a network entity 105. In some implementations, groups of the UEs 115 communicating via D2D communications may support a one-to-many (1:M) system in which each UE 115 transmits to each of the other UEs 115 in the group. In some implementations, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 also may operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some implementations, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some implementations, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some implementations, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some implementations, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which also may be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels.

The MAC layer also may use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some implementations, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some systems, such as the wireless communications system 100, a UE 115 may communicate with a network entity 105 over an unlicensed radio frequency band. In other words, the UE 115 may support unlicensed operation. In some aspects, the UE 115 may support unlicensed operation over a frequency range (FR) 2, such as an FR2-2 band (e.g., a 60 GHz band, which also may include a licensed band), and may support multiple channel access types. As described herein, a channel access type may refer to or otherwise be associated with a type of channel access procedure that a device (e.g., a UE 115) may perform to obtain access to a channel between the device and another device (e.g., a network entity 105) and different types of channel access procedures may be associated with different channel sensing or measurement operations. For example, the UE 115 may support a Type 1 channel access procedure, which may be equivalently referred to as or otherwise associated with a category (CAT) 3 listen-before-talk (LBT) procedure. In accordance with a Type 1 channel access procedure, the UE 115 may sense or measure the channel one or more times (e.g., over multiple measurement or sensing slots, multiple sets of symbols, or multiple measurement or sensing occasions) using a count-down (such that a count is reduced by one for each time the UE 115 measures the channel to be available). In some aspects, the UE 115 may employ a Type 1 channel access procedure to initiate a COT.

Additionally, or alternatively, the UE 115 may support a Type 2 channel access procedure, which may be equivalently referred to as or otherwise associated with a CAT 2 LBT procedure. In accordance with a Type 2 channel access procedure, the UE 115 may sense or measure the channel once (e.g., during one measurement or sensing slot, one set of symbols, or one measurement or sensing occasion). In other words, a Type 2 channel access procedure may be referred to or understood as a one-shot LBT procedure. In some aspects, the UE 115 may use a Type 2 channel access procedure to share a COT (e.g., the UE 115 may be constrained or restricted to using a Type 2 channel access procedure to share a COT in some region or regions). Additionally, or alternatively, the UE 115 may support a Type 3 channel access procedure, which may be equivalently referred to as or otherwise associated with a CAT 1 LBT procedure. In accordance with a Type 3 channel access procedure, the UE 115 may refrain from sensing or measuring the channel (e.g., may employ no LBT) prior to a transmission. In some aspects, the UE 115 may use a Type 3 channel access procedure to share a COT (e.g., the UE 115 may be allowed to use a Type 3 channel access procedure to share a COT in some region or regions).

The UE 115 may receive an indication of which type of channel access procedure to use for an uplink transmission from a network entity 105. For example, a network entity 105 may configure, for some DCI formats (e.g., a DCI format 1_1 or a DCI format 0_1), a channel access control field to indicate one or more channel access types. In other words, the network entity 105 may configure (e.g., via RRC signaling) a channel access control field in a DCI message (e.g., a DCI message associated with a DCI format 1_1 or 0_1) such that the network entity may dynamically indicate one or more channel access types to the UE 115 via the DCI message. Such a channel access control field may be referred to or denoted as a ChannelAccess-CPext-CAPC field for a DCI format 0_1 or as a ChannelAccess-CPext field for a DCI format 1_1.

In some aspects, the UE 115 may support one or multiple channel access-related features (e.g., one or multiple feature upgrades related to channel access). For example, the UE 115 may support a first feature upgrade according to which the UE 115 may upgrade from Type 1 channel access to Type 2 or Type 3 channel access if a corresponding uplink transmission falls in an already initiated COT. Additionally, or alternatively, the UE 115 may support a second feature upgrade according to which the UE 115, as an initiating device of a COT, may resume the COT that the UE 115 originally started using Type 2 or Type 3 channel access. Additionally, or alternatively, the UE 115 may support a third feature upgrade according to which the UE may use a contention-exempt signaling-based transmission (e.g., contention-exempt short control signaling-based transmission) for one or both of a msg1 or a msgA.

In aspects in which a UE 115 supports the first feature upgrade, a Type 1 channel access-based transmission, which may involve a relatively long clear channel assessment (CCA), may be “upgraded” to a Type 2 channel access- (e.g., one-shot LBT) or a Type 3 channel access- (e.g., no LBT) based transmission if the UE 115 identifies, determines, or otherwise ascertains that the transmission (e.g., an uplink transmission) falls within a COT of the network entity 105 with which the UE 115 is communicating. The UE 115 may support such a channel access-related upgrade for various types of transmissions, including for configured grant (CG) physical uplink shared channel (PUSCH) transmissions, dynamic grant PUSCH transmissions (scheduled in an earlier COT of the network entity 105), or periodic uplink transmissions such as physical uplink control channel (PUCCH) transmissions for one or more CSI reference signals (CSI-RSs), one or more sounding reference signals (SRSs), or one or more physical random access channel (PRACH) transmissions.

In some systems, such an upgrading behavior may be subject to one or more upgrading rules or regulations. For example, some upgrading rules may restrict an upgrade to different types of one-shot LBT procedures (e.g., different variants of Type 2 channel access procedures) while some other upgrading rules may extend or allow an upgrade to different types of one-shot LBT procedures or to a Type 3 channel access procedure (e.g., no LBT). In some aspects, such variations in upgrading rules may be associated with different geographic locations of a UE 115. For example, in some geographic locations (e.g., in Japan), a UE 115 may upgrade from Type 1 channel access to different variants of Type 2 channel access because regulations for such geographic locations may specify that an LBT procedure is to be performed before each transmission (such that an upgrade to Type 3 channel access may be restricted or not allowed). In some other geographic locations (e.g., in the European Union), a UE 115 may be allowed to share a COT with Type 3 channel access (as an upgrade from Type 1 channel access) because regulations for such geographic locations may allow some transmissions with no LBT. As such, whether a UE 115 is able to upgrade from Type 1 channel access to Type 2 channel access or is able to upgrade from Type 1 channel access to Type 3 channel access may vary in accordance with a location of the UE 115. A UE 115, however, may rely on signaling from a network entity 105 to indicate whether the UE 115 is allowed to upgrade to Type 2 channel access or to Type 3 channel access.

In aspects in which a UE 115 supports the second feature upgrade, the UE 115 may resume a COT that the UE 115 originally started in accordance with Type 1 channel access (e.g., such that the UE 115 is an initiating device for the COT) using Type 2 or Type 3 channel access. In some systems, a network entity 105 (as an initiating device) may similarly resume a COT that the network entity 105 originally started in accordance with Type 1 channel access using Type 2 or Type 3 channel access. With similarity to the first feature upgrade, whether a device (e.g., a UE 115 or a network entity 105) is able to upgrade to Type 2 channel access or to Type 3 channel access to resume the COT may depend on a geographic location of the device. For example, a UE 115 may be able to upgrade to Type 2 channel access (and restricted from upgrading to Type 3 channel access) in some geographic locations, but may be able to upgrade to Type 3 channel access in some other geographic locations.

A network entity 105 may be deployed at a fixed location, which may enable an operator to configure the network entity 105 (e.g., by implementation) with which channel access type to use if upgrading from Type 1 channel access based on the fixed location of the network entity 105. For example, the operator may configure the network entity 105 to be allowed to upgrade to Type 2 channel access or Type 3 channel access based on the location of the network entity 105. A UE 115, however, may be roaming and may rely on signaling from a network entity 105 to indicate whether the UE 115 is allowed to upgrade to Type 2 channel access or to Type 3 channel access.

In aspects in which a UE 115 supports the third feature upgrade, the UE 115 may use a contention-exempt signaling- (e.g., contention-exempt short control signaling) based transmission for msg1 (e.g., a PRACH transmission in a four-step random access procedure) or msgA (e.g., a PRACH transmission and a msgA-PUSCH transmission in a two-step random access procedure), at least in some regions. In other words, the UE 115 may send a msg1 or msgA without LBT assuming that a short control signaling condition is satisfied or otherwise met. In some aspects, such a condition may be associated with a usage or frequency of msg1 or msgA transmissions (e.g., the condition may be satisfied if a msg1 or msgA transmission occupies less than 10% over any 100 millisecond period). With similarity to the first feature upgrade and the second feature upgrade, whether the UE 115 is able to upgrade to use contention-exempt signaling (which may effectively be associated with Type 3 channel access) may depend on a geographic location of the device. For example, the UE 115 may be unable to use contention-exempt signaling for a msg1 or msgA transmission in some geographic locations, but may be able to use contention-exempt signaling for a msg1 or msgA transmission in some other geographic locations. A UE 115, however, may be roaming and may rely on signaling from a network entity 105 to indicate whether the UE 115 is allowed to use contention-exempt signaling (e.g., the network entity 105 may choose whether to enable the feature).

A UE 115 and a network entity 105, however, may lack an efficient, mutually understood or implemented signaling mechanism according to which the network entity 105 is able to control the UE 115 with respect to whether the UE 115 is allowed to upgrade to Type 2 channel access or to upgrade to Type 3 channel access. In some systems, for example, the UE 115 and the network entity 105 may introduce a configuration (e.g., an RRC configuration) to enable or disable one or more of the first feature upgrade, the second feature upgrade, and the third feature upgrade. Such a configuration, however, may be associated with relatively infrequent or high-latency signaling or a lack of flexibility. In other words, control designs involving further RRC configuration may sometimes be associated with or otherwise introduce relatively higher latency, may hinder system flexibility (e.g., may be more static than dynamic), and may be associated with a relatively higher overhead cost.

In some aspects, the UE 115 and the network entity 105 may support the configuration to enable or disable one or more of the feature upgrades (e.g., to control uplink transmission LBT procedures, such as all uplink transmission LBT procedures) via a flag in a system information block (SIB), such as SIB1. The UE 115 may use the flag in the SIB1 to determine whether Type 2 or Type 3 channel access is available for the UE 115 as part of the first feature upgrade, the second feature upgrade, the third feature upgrade, or any combination thereof (e.g., such that multiple feature upgrades may effectively be bundled to be controlled by a same flag). In aspects in which the flag is for the first feature upgrade, the UE 115 may upgrade to Type 2 channel access if the flag is set (e.g., if a bit in the SIB1 associated with the flag is set to a one value) and may upgrade to Type 3 channel access if the flag is not set (e.g., if a bit in the SIB1 associated with the flag is set to a zero value). Additionally, or alternatively, in aspects in which the flag is for the second feature upgrade, the UE 115 may use Type 2 channel access to resume a COT if the flag is set and may use Type 3 channel access to resume a COT if the flag is not set. Additionally, or alternatively, in aspects in which the flag is for the third feature upgrade, the UE 115 may not use contention-exempt short control signaling (e.g., may use contention-based signaling, such as signaling involving at least some LBT measurements) for a msg1 or msgA transmission if the flag is set and may use contention-exempt short control signaling for a msg1 or msgA transmission if the flag is not set.

In some aspects, the UE 115 and the network entity 105 may support the configuration to enable or disable one or more of the feature upgrades via a UE-specific configuration (e.g., a UE-specific RRC configuration, such as an information element or parameter). Accordingly, the UE-specific configuration may indicate to which channel access type (e.g., which of Type 2 or Type 3) the UE 115 is allowed to upgrade to share a COT of a network entity 105 or to resume a previous COT of the UE 115. Further, the UE-specific configuration may indicate whether the UE 115 is allowed to resume a COT (e.g., a previously released COT). In aspects in which a UE 115 and a network entity 105 support a UE-specific configuration for the third feature upgrade, the UE-specific configuration (e.g., which may be included in an RMSI message) may indicate whether the UE 115 is allowed to perform a short control signaling-based msg1 or msgA transmission.

Instead of or to supplement any of such RRC configuration-based control designs, a UE 115 and a network entity 105 may, in some implementations, support a control mechanism according to which the UE 115 may determine which channel access type the UE 115 is allowed to use in various scenarios in which at least one of the first feature upgrade, the second feature upgrade, or the third feature upgrade is available to the UE 115. In other words, the UE 115 may determine whether an upgrade from a first channel access type to a second channel access type is available for an uplink transmission from the UE 115 to the network entity 105 in accordance with the control mechanism. For example, in scenarios in which an uplink message is initially scheduled or configured with a Type 1 channel access procedure and in which the uplink message overlaps with a COT of the network entity 105, the UE 115 may (as part of the first feature upgrade) attempt to obtain access to a channel between the UE 115 and the network entity 105 for the uplink message in accordance with a Type 2 or a Type 3 channel access procedure based on whether the network entity configures a Type 2 or a Type 3 channel access procedure as potentially or possibly available to the UE 115.

Additionally, or alternatively, in scenarios in which the UE 115 initiates a COT for a first uplink message in accordance with a Type 1 channel access procedure and is scheduled or configured to transmit a second uplink message after releasing the COT, the UE 115 may (as part of the second feature upgrade) attempt to resume the COT in accordance with a Type 2 or a Type 3 channel access procedure based on whether the network entity configures a Type 2 or a Type 3 channel access procedure as potentially or possibly available to the UE 115. In other words, the network entity 105 may configure (e.g., RRC configure) the UE 115 with a set of possible or available channel access types and the UE 115 may determine which of Type 2 or Type 3 channel access is available for the first feature upgrade or the second feature upgrade, or both, based on which channel access types are present in the set of possible or available channel access types. Additionally, or alternatively, the UE 115 and the network entity 105 may support a channel access control field in a broadcast DCI message that schedules system information (e.g., RMSI) and the network entity 105 may use the channel access control field in the broadcast DCI message to indicate whether the UE 115 is to transmit a msg1 or msgA in accordance with contention-based signaling or in accordance with contention-exempt signaling.

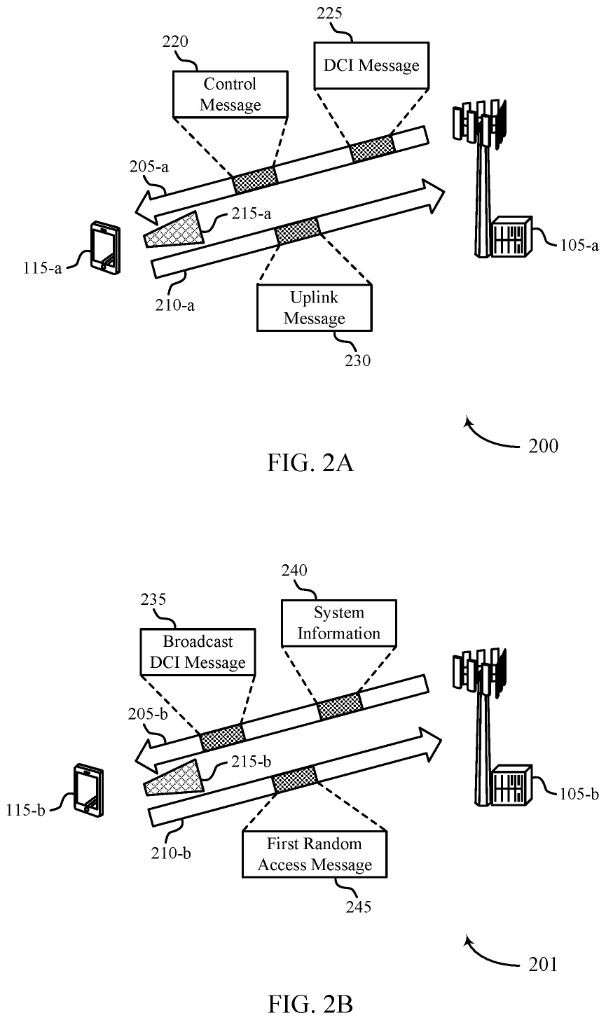

FIG. 2A illustrates an example of a wireless communications system 200 that supports control mechanisms for uplink channel access types in accordance with one or more aspects of the present disclosure. The wireless communications system 200 may implement or be implemented to realize aspects of the wireless communications system 100. For example, the wireless communications system 200 may illustrate communication between a network entity 105-a and a UE 115-a, which may be examples of corresponding devices as illustrated by and described with reference to FIG. 1.

In some implementations, the UE 115-a and the network entity 105-a may support a configuration- (e.g., behavior-) and signaling-based control mechanism according to which the UE 115-a may determine whether the UE 115-a is able to occupy a channel for an uplink transmission to the network entity 105-a in accordance with a Type 2 channel access procedure or a Type 3 channel access procedure via the first feature upgrade or the second feature upgrade. In such implementations, the UE 115-a may receive, from the network entity 105-a via a downlink 205-a, a control message 220 that indicates a set of channel access types that are available to the UE 115-a for communications between the UE 115-a and the network entity 105-a and the UE 115-a may implicitly determine which of Type 2 channel access or Type 3 channel access the UE 115-a may use as part of the first feature upgrade or as part of the second feature upgrade, or both, based on which of Type 2 or Type 3 channel access is present in the set of channel access types.

For example, and in the context of the first feature upgrade, the UE 115-a may receive a DCI message 225 that schedules an uplink message 230 from the UE 115-a to the network entity 105-a via an uplink 210-a. The DCI message 225 may indicate that the UE 115-a is to use Type 1 channel access for an LBT procedure 215-a prior to transmission of the uplink message 230 and the UE 115-a may upgrade from Type 1 channel access to either Type 2 channel access or Type 3 channel access if the uplink message 230 is scheduled during or otherwise falls within a COT of the network entity 105-a. In scenarios in which the uplink message 230 falls within a COT of the network entity 105-a, the UE 115-a may determine to which of Type 2 or Type 3 channel access the UE 115-a is allowed to upgrade based on a presence of Type 2 channel access or a presence of Type 3 channel access in the set of channel access types indicated by the control message 220.

In the context of a second feature upgrade, the UE 115-a may receive a DCI message 225 that schedules a relatively earlier uplink message (e.g., relatively earlier than the uplink message 230) and the DCI message 225 may indicate that the UE 115-a is to use Type 1 channel access for an LBT procedure 215-a to obtain a COT for the earlier uplink message. As such, the UE 115-a may obtain a COT for the earlier uplink message in accordance with a Type 1 channel access procedure and transmit the earlier uplink message during the COT. In some aspects, the UE 115-a may release the COT after the transmission. If the UE 115 is scheduled or configured to transmit the uplink message 230 after the earlier uplink message, the UE 115-a (as an initiating device) may resume the COT that the UE 115-a originally started for the earlier uplink message with Type 1 channel access in accordance with either Type 2 or Type 3 channel access based on the second feature upgrade. In some implementations, the UE 115-a may determine to which of Type 2 or Type 3 channel access the UE 115-a is allowed to upgrade based on a presence of Type 2 channel access or a presence of Type 3 channel access in the set of channel access types indicated by the control message 220.

In some aspects, such a presence of Type 2 channel access and a presence of Type 3 channel access in the set of channel access types indicated by the control message 220 may depend on whether the control message 220 indicates one or both of Type 2 and Type 3 channel access in one or more channel access-related mappings. For example, a DCI message 225 may include a set of one or more bits in a channel access control field and the control message 220 may indicate a mapping between different permutations of the set of one or more bits and different channel access types (such that a DCI message 225 is able to indicate a channel access type along with scheduling a transmission). Thus, if there exists a correspondence between one or more permutations of the set of one or more bits and a Type 2 channel access procedure in accordance with a mapping indicated by the control message 220, the UE 115-a may interpret the Type 2 channel access procedure as present in the set of channel access types indicated by the control message 220. Similarly, if there exists a correspondence between one or more permutations of the set of one or more bits and a Type 3 channel access procedure in accordance with a mapping indicated by the control message 220, the UE 115-a may interpret the Type 3 channel access procedure as present in the set of channel access types indicated by the control message 220.

Accordingly, in some implementations, the UE 115-a may use Type 2 channel access for the uplink message 230 as part of the first feature upgrade (e.g., an uplink transmission within a COT of the network entity 105-a) or the second feature upgrade (e.g., to resume a COT) if the UE 115-a is configured with an entry of Type 2 channel access in accordance with a mapping indicated by the control message 220. Additionally, or alternatively, the UE 115-a may use Type 2 channel access for the uplink message 230 as part of the first feature upgrade (e.g., an uplink transmission within a COT of the network entity 105-a) or the second feature upgrade (e.g., to resume a COT) if the UE 115-a is not configured with an entry of Type 3 channel access in accordance with a mapping indicated by the control message 220.

In some other implementations, the UE 115-a may use Type 3 channel access for the uplink message 230 as part of the first feature upgrade (e.g., an uplink transmission within a COT of the network entity 105-a) or the second feature upgrade (e.g., to resume a COT) if the UE 115-a is configured with an entry of Type 3 channel access in accordance with a mapping indicated by the control message 220. Additionally, or alternatively, the UE 115-a may use Type 3 channel access for the uplink message 230 as part of the first feature upgrade (e.g., an uplink transmission within a COT of the network entity 105-a) or the second feature upgrade (e.g., to resume a COT) if the UE 115-a is not configured with an entry of Type 2 channel access in accordance with a mapping indicated by the control message 220.

In some aspects, the control message 220 may indicate a mapping (e.g., a single or a same mapping) that is applicable to multiple DCI formats. For example, the control message 220 may indicate a mapping that is applicable to both DCI messages associated with a DCI format 0_1 and DCI messages associated with a DCI format 1_1. In such aspects, a channel access type may be present in the set of channel access types (and thus available for the first feature upgrade or the second feature upgrade, or both) if there exists a correspondence between that channel access type and a permutation of the set of one or more bits in a DCI message 225 in accordance with the single mapping.

In some other aspects, the control message 220 may indicate a different mapping for each of multiple DCI formats. For example, the control message 220 may indicate a first mapping that is applicable to DCI messages associated with a DCI format 0_1 and may indicate a second mapping that is applicable to DCI messages associated with a DCI format 1_1. As such, a DCI format 0_1 can indicate a specific channel access type if the first mapping includes an entry for that specific channel access type and a DCI format 1_1 can indicate a specific channel access type if the second mapping includes an entry for that specific channel access type.

In such aspects, a channel access type may be present in the set of channel access types if there exists a correspondence between that channel access type and a permutation of the set of one or more bits in a DCI message 225 in accordance with one or both of the first mapping and the second mapping. For example, the UE 115-a may determine or expect that a channel access type is present in the set of channel access types (and thus available for the first feature upgrade or the second feature upgrade, or both) if the channel access type is present in accordance with at least one of the first mapping and the second mapping, if the channel access type is present in accordance with both of the first mapping and the second mapping, if the channel access type is present in accordance with the first mapping (e.g., the first mapping only), or if the channel access type is present in accordance with the second mapping (e.g., the second mapping only). In an example, Type 2 channel access may be configured via the control message 220 (and present in the set of channel access types) if Type 2 channel access is configured in (e.g., capable of being conveyed by) one of DCI format 0_1 and DCI format 1_1, in both DCI format 0_1 and DCI format 1_1, in DCI format 0_1 only, or in DCI format 1_1 only.

As such, the UE 115-a and the network entity 105-a may effectively bundle an enablement or disablement of the first feature upgrade or the second feature upgrade, or both, with a DCI format 0_1 channel access control field configuration or a DCI format 1_1 channel access control field configuration, or both. Accordingly, if the network entity 105-a allows the UE 115-a to use, for example, an LBT procedure 215-a associated with Type 2 channel access (e.g., in accordance with a local regulation), the network entity 105-a may configure Type 2 channel access for DCI format 0_1 or DCI format 1_1, or both, and the UE 115-a may assume that Type 2 channel access is also available for one or both of the first feature upgrade or the second feature upgrade. In other words, the UE 115-a may determine or expect that restrictions associated with a Type 1 channel access upgrade (e.g., the first feature upgrade) or a UE COT resumption (e.g., the second feature upgrade) will follow or otherwise align with which channel access types are indicated as available to the UE 115-a via the control message 220. The configuration of the DCI formats 0_1 and 1_1 may be UE-specific and may be communicated between the UE 115-a and the network entity 105-a after initial access.

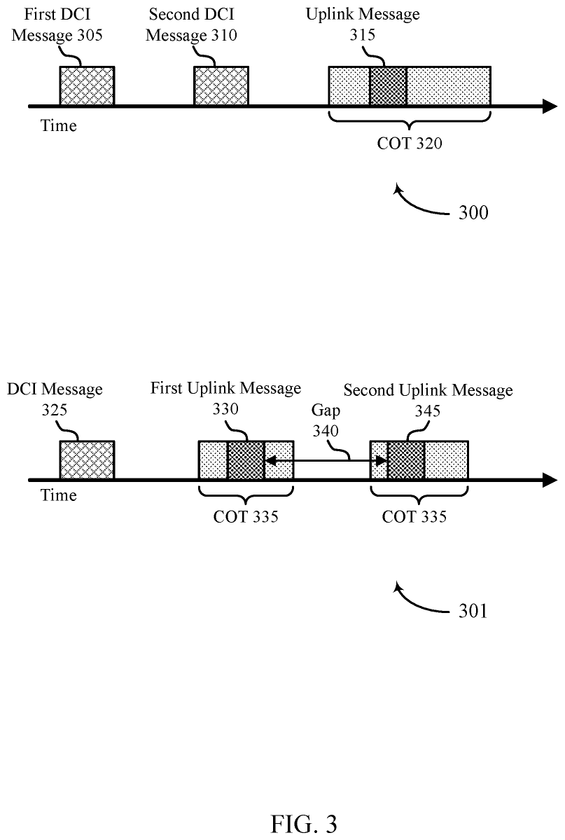

As such, the UE 115-a and the network entity 105-a may support an efficient control mechanism for one or both of the first feature upgrade or the second feature upgrade via which specific channel access types are included in a set of channel access types indicated by the control message 220. For example, the UE 115-a and the network entity 105-a may implement such a control mechanism without additional signaling (e.g., without an additional RRC parameter), which may reduce signaling overhead. Additional details relating to the first feature upgrade and the second feature upgrade are illustrated by and described with reference to FIG. 3. Further, although illustrated and described as one message, the control message 220 may be one or multiple messages. For example, the UE 115-a may receive the control message 220 via RRC signaling (such that the control message 220 may be an example of one or more RRC messages) and the control message 220 may include one or more RRC information elements or parameters associated with a DCI channel access control field. Similarly, the UE 115-a may apply the first feature upgrade or the second feature upgrade to one or more other uplink messages from the UE 115-a.

FIG. 2B illustrates an example of a wireless communications system 201 that supports control mechanisms for uplink channel access types in accordance with one or more aspects of the present disclosure. The wireless communications system 201 may implement or be implemented to realize aspects of the wireless communications system 100. For example, the wireless communications system 201 may illustrate communication between a network entity 105-b and a UE 115-b, which may be examples of corresponding devices as illustrated by and described with reference to FIG. 1. In some implementations, the UE 115-b and the network entity 105-b may support a configuration- (e.g., behavior-) and signaling-based control mechanism according to which the UE 115-b may determine whether the UE 115-b is able to determine whether the UE 115-b is to use contention-exempt signaling or contention-based signaling for an initial random access message via the third feature upgrade.

For example, the UE 115-b may attempt to establish a connection with the network entity 105-b and, as such, may monitor for system information 240 from the network entity 105-b to obtain information that the UE 115-b may use for transmitting random access messaging to the network entity 105-b. In some aspects, the network entity 105-b may schedule some system information 240 (e.g., RMSI) via a broadcast DCI message 235. For example, the network entity 105-b may indicate a set of resources (e.g., may provide a resource grant) for the system information 240 via the broadcast DCI message 235. The broadcast DCI message 235 may be an example of a DCI format 1_0 and the network entity 105-b may scramble the broadcast DCI message 235 based on a system information radio network temporary identifier (SI-RNTI). For example, the network entity 105-b may scramble one or more cyclic redundancy check (CRC) bits of the broadcast DCI message 235 based on the SI-RNTI (such that the broadcast DCI message 235 may be CRC scrambled by SI-RNTI).

As such, the UE 115-b may receive, from the network entity 105-b via a downlink 205-b, the broadcast DCI message 235 that schedules the system information 240 (e.g., the RMSI) and the UE 115-b may use a content of the system information 240 to transmit, to the network entity 105-b via an uplink 210-b, a first random access message 245 (e.g., a msg1 or msgA). In other words, before the UE 115-b transmits the first random access message 245, the UE 115-b may receive the system information 240 (e.g., the RMSI) to collect, determine, identify, or otherwise obtain one or more parameters for the first random access message 245 (e.g., for a msg1 or msgA transmission).

In some implementations, the UE 115-b and the network entity 105-b may use the broadcast DCI message 235 (e.g., the DCI format 1_0 that grants the RMSI and that is CRC scrambled by SI-RNTI) to indicate or determine whether the UE 115-b is to send the first random access message 245 (e.g., a msg1 or msgA) using contention-exempt short control signaling (which may not involve any LBT) or using contention-based signaling. In some aspects, for example, the UE 115-b and the network entity 105-b may support or include a channel access control field in the broadcast DCI message 235 (e.g., the UE 115-b and the network entity 105-b may support a DCI format 1_0 that includes a channel access control field). In some aspects, such a channel access control field may be denoted as a ChannelAccess-CPext field in the broadcast DCI message 235. The UE 115-b may use the indication in the channel access control field to determine whether to perform an LBT procedure 215-b prior to transmitting the first random access message 245.

In some systems, a channel access control field may be present in a DCI format 1_0 that the network entity 105-b scrambles by a cell RNTI (C-RNTI) or a temporary C-RNTI (TC-RNTI), as such DCI messages scrambled by C-RNTI or TC-RNTI schedule or trigger an uplink transmission (e.g., an acknowledgement (ACK) or a negative ACK (NACK)), while DCI messages scrambled by SI-RNTI are broadcast messages (e.g., may not schedule or trigger an uplink transmission). As such, the UE 115-b and the network entity 105-b may introduce a channel access control field in the broadcast DCI message 235 (e.g., a DCI message that is broadcast and scrambled by SI-RNTI) to indicate whether the UE 115-b is to use contention-based signaling or contention-exempt signaling for the first random access message 245.

In some aspects, the UE 115-b and the network entity 105-b may use a configured mapping or interpretation to support the indication of contention-based signaling or contention-exempt signaling for the first random access message 245. In other words, the UE 115-b may interpret a content of a channel access control field in the broadcast DCI message 235 in accordance with the configured mapping or interpretation. For example, if a msg1 or msgA contention-exempt short control signaling transmission is allowed for the UE 115-b, the network entity 105-b may set the channel access control field in the broadcast DCI message 235 to a first value (e.g., a first bit value or first permutation of one or more bits in the channel access control field). Alternatively, if a msg1 or msgA contention-exempt short control signaling transmission is not allowed for the UE 115-b, the network entity 105-b may set the channel access control field in the broadcast DCI message 235 to a second value (e.g., a second bit value or a second permutation of one or more bits in the channel access control field).

Likewise, the UE 115-b may interpret the first value in the channel access control field as indicating that the UE 115-b is to transmit the first random access message 245 using contention-exempt signaling and may interpret the second value in the channel access control field as indicating that the UE 115-b is to transmit the first random access message 245 using contention-based signaling in accordance with the configured mapping. In some aspects, the first value may map or correspond to Type 3 channel access (e.g., in accordance with the configured mapping) and the second value may map or correspond to Type 1 channel access (e.g., in accordance with the configured mapping). In some implementations, the network entity 105-b may transmit control signaling (e.g., one or more DCI messages, one or more RRC messages, or one or more MAC control elements (MAC-CEs)) to the UE 115-b that indicates the configured mapping between different values or permutations of one or more bits in the channel access control field of the broadcast DCI message 235 and different channel access types (or between different values or permutations of one or more bits in the channel access control field of the broadcast DCI message 235 and LBT or no LBT).

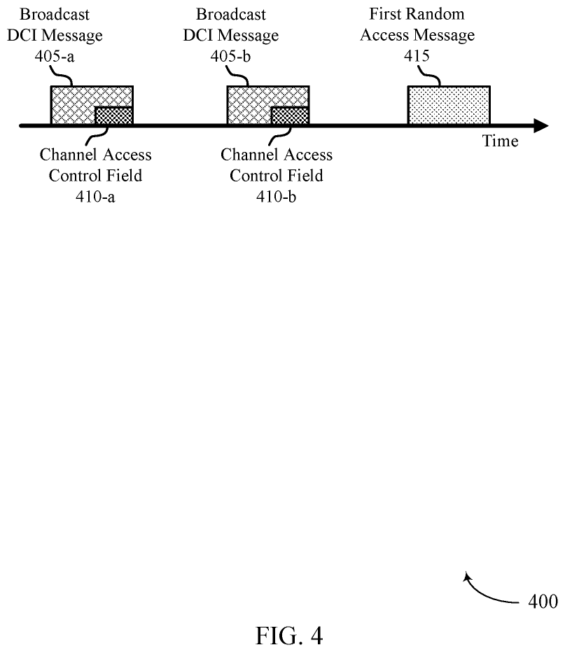

Accordingly, the UE 115-b and the network entity 105-b may support a control mechanism design that enables or disables the third feature upgrade with dynamic control in DCI 1_0 that is CRC scrambled by SI-RNTI. Such a dynamic indication of whether the UE 115-b is allowed to implement the third feature upgrade may provide greater flexibility and lower latency, while also being associated with a relatively lower overhead cost (e.g., as compared to a use of an RRC parameter to indicate the enablement or disablement of the third feature upgrade). Additional details relating to the control mechanism according to which the UE 115-b determines to use either contention-exempt signaling or contention-based signaling for the first random access message 245 are illustrated by and described in more detail with reference to FIG. 4.

FIG. 3 illustrates examples of communication timelines 300 and 301 that support control mechanisms for uplink channel access types in accordance with one or more aspects of the present disclosure. The communication timelines 300 and 301 may implement or be implemented by aspects of the wireless communications system 100 or the wireless communications system 200. For example, the communication timeline 300 illustrates communication between a UE 115 and a network entity 105 (which may be examples of corresponding devices as illustrated by and described with reference to FIGS. 1 and 2) in a scenario associated with the first feature upgrade. Further, the communication timeline 301 illustrates communication between a UE 115 and a network entity 105 (which may be examples of corresponding devices as illustrated by and described with reference to FIGS. 1 and 2) in a scenario associated with the second feature upgrade.

In the context of the communication timeline 300, the UE 115 may receive a first DCI message 305 from the network entity 105 and the first DCI message 305 may schedule an uplink message 315 and indicate that the UE 115 is to use a first channel access type (e.g., Type 1 channel access) for the uplink message 315. The first DCI message may be an example of a DCI message 225 as illustrated by and described with reference to FIG. 2. In some scenarios, the UE 115 may later receive, from the network entity 105, a second DCI message 310 that indicates a slot format for communication between the UE 115 and the network entity 105 and the slot format may indicate that the uplink message 315 falls within a COT 320 of the network entity 105.

For example, the second DCI message 310, which may be associated with a DCI format 2_0, may indicate a starting time and a duration of the COT 320 of the network entity 105 and the UE 115 may determine that the scheduled uplink message 315 falls within the COT 320 based on the indicated starting time and duration. In some aspects, the second DCI message 310 may indicate the COT 320 via indicating a set of one or more symbols or slots that are assigned for downlink communication from the network entity 105. In such scenarios in which the uplink message 315 falls within the COT 320 of the network entity 105, the UE 115 may upgrade from Type 1 channel access to either Type 2 channel access or Type 3 channel access based on whether Type 2 channel access or Type 3 channel access, or both, is present in a set of channel access types indicated by a control message (e.g., the control message 220 as described with reference to FIG. 2).

In the context of the communication timeline 301, the UE 115 may receive a DCI message 325 and the DCI message 325 may schedule a first uplink message 330 and indicate that the UE 115 is to use Type 1 channel access to initiate a COT 335 for the first uplink message 330. The UE 115 may perform a Type 1 channel access procedure to initiate the COT 335 and transmit the first uplink message 330 to the network entity 105 during the COT 335 accordingly. The UE 115 may release or otherwise terminate the COT 335 after the transmission of the first uplink message 330 and, in some scenarios, may be scheduled or configured to transmit again after the first uplink message 330 with a gap 340 or after a responding device transmission (e.g., after a downlink message from the network entity 105 responsive to the first uplink message 330).

For example, the UE 115 may receive a scheduling message or a configuration to transmit a second uplink message 345 after a gap 340 from the first uplink message 330 and, in scenarios in which the COT 335 used for the first uplink message 330 is less than a threshold COT (e.g., less than a maximum or upper limit COT duration) associated with the first uplink, the UE 115 may employ the second feature upgrade to resume the COT 335 for the second uplink message. In such examples, the UE 115 may upgrade to use either Type 2 channel access or Type 3 channel access to resume the COT 335 for the second uplink message 345 based on whether Type 2 channel access or Type 3 channel access, or both, are present in a set of channel access types indicated by a control message (e.g., the control message 220 as described with reference to FIG. 2).

FIG. 4 illustrates an example of a communication timeline 400 that supports control mechanisms for uplink channel access types in accordance with one or more aspects of the present disclosure. The communication timeline 400 may implement or be implemented by aspects of the wireless communications system 100 or the wireless communications system 201. For example, the communication timeline 400 illustrates communication between a UE 115 and a network entity 105 (which may be examples of corresponding devices as illustrated by and described with reference to FIGS. 1 and 2) in a scenario associated with the third feature upgrade.

For example, the UE 115 may monitor for broadcast DCI messages 405 from the network entity 105 to receive scheduling information for system information, such as RMSI, which the UE 115 may use to transmit a first random access message 415 (e.g., a msg1 or msgA, and which may be an example of the first random access message 245 as described with reference to FIG. 2). In some aspects, a broadcast DCI message 405 may include a channel access control field 410 that includes a set of one or more bits and the network entity 105 may use a value or permutation of the set of one or more bits to indicate whether the UE 115 is to use contention-exempt signaling or contention-based signaling for the first random access message 415.

In some implementations, the UE 115 may receive multiple broadcast DCI messages 405. In other words, the UE 115 may receive different instances of a broadcast DCI message 405 (which may be associated with a DCI format 1_0 scrambled by SI-RNTI and which may be an example of a broadcast DCI message 235 as described with reference to FIG. 2). In some aspects, different instances of the broadcast DCI message 405 may carry different information, such as different information in their respective channel access control fields 410. For example, some broadcast DCI messages 405 may enable contention-exempt signaling for the first random access message 415 while some other broadcast DCI messages 405 may disable contention-exempt signaling for the first random access message 415.

In the context of the communication timeline 400, the UE 115 may receive a first broadcast DCI message 405-a that includes a channel access control field 410-a and may receive a second broadcast DCI message 405-b that includes a channel access control field 410-b. In some implementations, the UE 115 and the network entity 105 may communicate in accordance with a restriction, configuration, or rule such that the UE 115 does not expect to see differences between a content of the channel access control field 410-a and the channel access control field 410-b (or any differences between the first broadcast DCI message 405-a and the second broadcast DCI message 405-b).

Additionally, or alternatively, the UE 115 may prioritize one behavior (e.g., one of using contention-exempt signaling and contention-based signaling) if the UE 115 receives multiple broadcast DCI messages 405 including different channel access control fields 410. For example, the UE 115 and the network entity 105 may employ a prioritization rule that prioritizes either contention-exempt signaling or contention-based signaling. In implementations in which the UE 115 prioritizes contention-based signaling, for example, the UE 115 may use contention-based signaling (and may not use contention-exempt signaling) for the first random access message 415 if the UE 115 receives at least one broadcast DCI message 405 with SI-RNTI that indicates contention-based signaling (e.g., via an indication of Type 1 channel access).

Alternatively, in implementations in which the UE 115 prioritizes contention-exempt signaling, the UE 115 may use contention-exempt signaling for the first random access message 415 if the UE 115 receives at least one broadcast DCI message 405 with SI-RNTI that indicates contention-exempt signaling (e.g., via an indication of Type 3 channel access). Additionally, or alternatively, the UE 115 may determine to use contention-based signaling or contention-exempt signaling based on a relative quantity of respective indications. For example, if the UE 115 receives two indications for contention-exempt signaling and one indication for contention-based signaling, the UE 115 may transmit the first random access message 415 using contention-exempt signaling. In accordance with any of such prioritization rules, the UE 115 and the network entity 105 may avoid confusion as to whether the UE 115 is expected to use contention-based signaling or contention-exempt signaling.

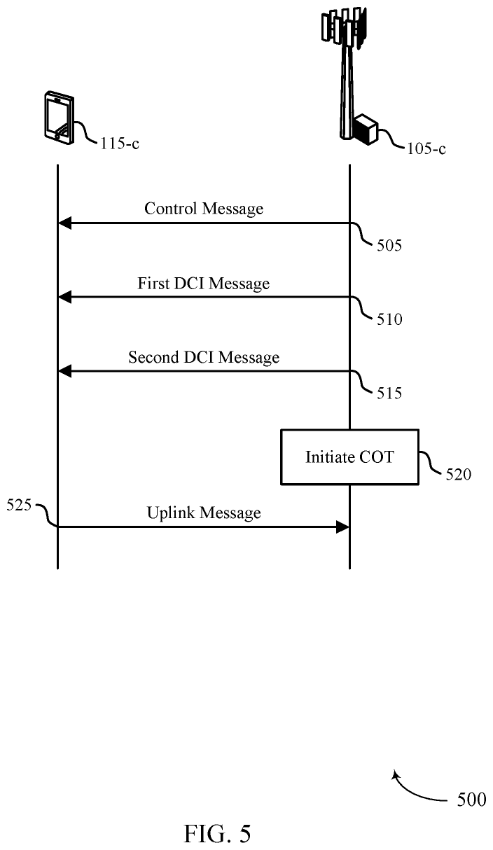

FIG. 5 illustrates an example of a process flow 500 that supports control mechanisms for uplink channel access types in accordance with one or more aspects of the present disclosure. The process flow 500 may implement or be implemented by aspects of the wireless communications system 100, the wireless communications system 200, and the communication timeline 300. For example, the process flow 500 illustrates communication between a UE 115-c and a network entity 105-c, which may be examples of corresponding devices as illustrated by and described with reference to FIGS. 1 and 2. In some implementations, the UE 115-c may support the first feature upgrade associated with channel access based on which channel access types are configured as available to the UE 115-c.

In the following description of the process flow 500, the operations may be performed (e.g., reported or provided) in a different order than the order shown, or the operations performed by the example devices may be performed in different orders or at different times. Some operations also may be left out of the process flow 500, or other operations may be added to the process flow 500. Further, although some operations or signaling may be shown to occur at different times for discussion purposes, these operations may actually occur at the same time. Further, although communication is illustrated by and described in the context of the process flow 500 as being performed between a UE 115 and a network entity 105, such communication may be performed between any two or more devices. For example, the described communication may be performed between a first network node and a second network node.

At 505, the UE 115-c may receive, from the network entity 105-c, a control message that indicates a set of one or more channel access types that are available to the UE 115-c for communications between the UE 115-c and the network entity 105-c. In some aspects, the set of channel access types that are available to the UE 115-c may include a first channel access type (e.g., Type 1 channel access) and at least one of a first candidate channel access type (e.g., Type 2 channel access) or a second candidate channel access type (e.g., Type 3 channel access). In some aspects, the first channel access type may include one or more channel sensing operations, the first candidate channel access type may include a single channel sensing operation, and the second candidate channel access type may exclude channel sensing operations, wherein each respective channel sensing operation is a respective LBT operation or measurement.

In some implementations, the control message may indicate a single mapping between each respective permutation of multiple permutations of a set of one or more bits and each respective channel access type of the set of one or more channel access types. Additionally, or alternatively, the control message may indicate a first mapping between each respective permutation of the multiple permutations of the set of one or more bits and each respective channel access type of a first set of one or more channel access types and a second mapping between each respective permutation of the multiple permutations of the set of one or more bits and each respective channel access type of a second set of one or more channel access types, where the set of one or more channel access types includes both the first set and the second set of one or more channel access types.

The control message may indicate the first mapping for DCI messages associated with scheduling uplink, such as PUSCH, communication (e.g., DCI formats 0_1) and may indicate the second mapping for DCI messages associated with scheduling downlink, such as PDSCH, communication (e.g., DCI formats 1_1). In some implementations, the control message may enable or disable an upgrade (e.g., the first feature upgrade), for an uplink message, from a first channel access type (e.g., Type 1 channel access) to a second channel access type (e.g., one of Type 2 or Type 3 channel access) during a COT of the network entity 105-c based on whether the second channel access type is present in the set of one or more channel access types.

At 510, the UE 115-c may receive, from the network entity 105-c, a first DCI message that schedules an uplink message from the UE 115-c and indicates, for the uplink message, a first channel access type (e.g., Type 1 channel access) from the set of one or more channel access types.

At 515, the UE 115-c may receive, from the network entity 105-c, a second DCI message that indicates a slot format. In some aspects, the slot format may indicate a COT of the network entity 105-c. For example, the slot format may indicate a starting time and a duration of the COT of the network entity 105-c. In some scenarios, the UE 115-c may determine that the uplink message is scheduled during a time resource that at least partially overlaps with the COT of the network entity 105-c. The second DCI message may be associated with a DCI format 2_0.

At 520, the network entity 105-c may initiate a COT of the network entity 105-c. In some aspects, the network entity 105-c may initiate the COT based on the second DCI message and in accordance with a specific channel access type (e.g., in accordance with Type 1 channel access).

At 525, the UE 115-c may transmit, during the COT of the network entity 105-c and based on whether a second channel access type (e.g., either Type 2 or Type 3 channel access) is present in the set of one or more channel access types indicated by the control message, the uplink message in accordance with the second channel access type. In some aspects, the second channel access type may be either a first candidate channel access type (e.g., Type 2 channel access) or a second candidate channel access type (e.g., Type 3 channel access) and the UE 115-c may transmit the uplink message in accordance with either the first candidate channel access type or the second candidate channel access type based on which of the first candidate channel access type or the second candidate channel access type is present or included in the set of one or more channel access types (if not both).

For example, the UE 115-c may transmit the uplink message in accordance with the first candidate channel access type if the first candidate channel access type is included in the set of one or more channel access types or if the second candidate channel access type is excluded from the set of one or more channel access types. Alternatively, the UE 115-c may transmit the uplink message in accordance with the second candidate channel access type if the second candidate channel access type is included in the set of one or more channel access types or if the first candidate channel access type is excluded from the set of one or more channel access types. If both the first candidate channel access type and the second candidate channel access type are present or included in the set of one or more channel access types, the UE 115 may select one of the first candidate channel access type or the second candidate channel access type in accordance with a predefined rule. For example, if the first candidate channel access type (e.g., Type 2 channel access) is present, the UE 115 may select to use the first candidate channel access type (regardless of whether the second candidate channel access type is present).

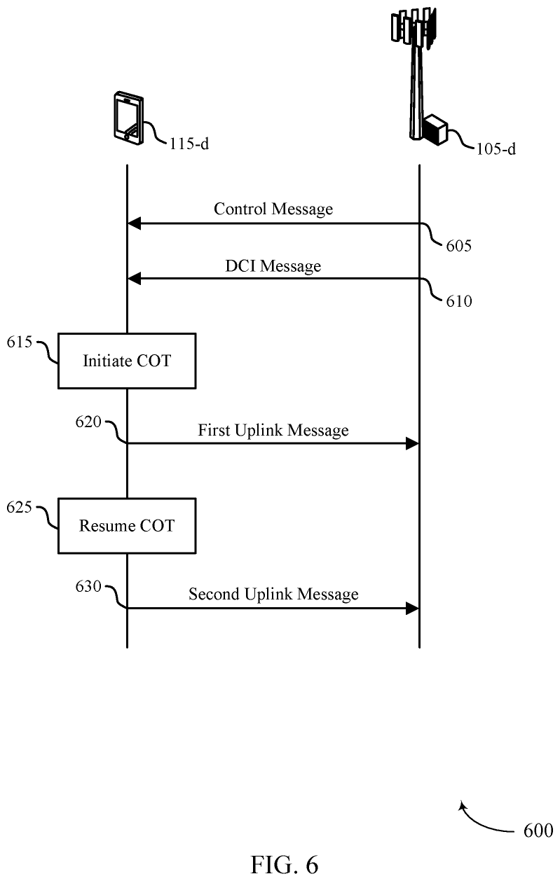

FIG. 6 illustrates an example of a process flow 600 that supports control mechanisms for uplink channel access types in accordance with one or more aspects of the present disclosure. The process flow 600 may implement or be implemented by aspects of the wireless communications system 100, the wireless communications system 200, and the communication timeline 301. For example, the process flow 600 illustrates communication between a UE 115-d and a network entity 105-d, which may be examples of corresponding devices as illustrated by and described with reference to FIGS. 1 and 2. In some implementations, the UE 115-d may support the second feature upgrade associated with channel access based on which channel access types are configured as available to the UE 115-d.

In the following description of the process flow 600, the operations may be performed (e.g., reported or provided) in a different order than the order shown, or the operations performed by the example devices may be performed in different orders or at different times. Some operations also may be left out of the process flow 600, or other operations may be added to the process flow 600. Further, although some operations or signaling may be shown to occur at different times for discussion purposes, these operations may actually occur at the same time. Further, although communication is illustrated by and described in the context of the process flow 600 as being performed between a UE 115 and a network entity 105, such communication may be performed between any two or more devices. For example, the described communication may be performed between a first network node and a second network node.

At 605, the UE 115-d may receive, from the network entity 105-d, a control message that indicates a set of one or more channel access types that are available to the UE 115-d for communications between the UE 115-d and the network entity 105-d. In some aspects, the set of channel access types that are available to the UE 115-d may include a first channel access type (e.g., Type 1 channel access) and at least one of a first candidate channel access type (e.g., Type 2 channel access) or a second candidate channel access type (e.g., Type 3 channel access). In some aspects, the first channel access type may include one or more channel sensing operations, the first candidate channel access type may include a single channel sensing operation, and the second candidate channel access type may exclude channel sensing operations, wherein each respective channel sensing operation is a respective LBT operation or measurement.

In some implementations, the control message may indicate a mapping between each respective permutation of multiple permutations of a set of one or more bits and each respective channel access type of the set of one or more channel access types. Additionally, or alternatively, the control message may indicate a first mapping between each respective permutation of the multiple permutations of the set of one or more bits and each respective channel access type of a first set of one or more channel access types and a second mapping between each respective permutation of the multiple permutations of the set of one or more bits and each respective channel access type of a second set of one or more channel access types, wherein the set of one or more channel access types includes both the first set and the second set of one or more channel access types.

The control message may indicate the first mapping for DCI messages associated with scheduling uplink, such as PUSCH, communication (e.g., DCI formats 0_1) and may indicate the second mapping for DCI messages associated with scheduling downlink, such as PDSCH, communication (e.g., DCI formats 1_1). In some implementations, the control message may enable or disable an upgrade (e.g., the first feature upgrade), for an uplink message, from a first channel access type (e.g., Type 1 channel access) to a second channel access type (e.g., one of Type 2 or Type 3 channel access) during a COT of the network entity 105-c based on whether the second channel access type is present in the set of one or more channel access types.

At 610, the UE 115-d may receive, from the network entity 105-d, a DCI message that schedules a first uplink message and indicates, for the first uplink message, a first channel access type (e.g., Type 1 channel access).

At 615, the UE 115-d may initiate a COT in accordance with the first channel access type. For example, the UE 115-d may perform one or more channel sensing operations associated with the first channel access type and may initiate the COT upon measuring or otherwise determining that the channel is available for the first uplink message from the UE 115-d.

At 620, the UE 115-d may transmit, to the network entity 105-d, the first uplink message during the COT obtained via the first channel access type. In some aspects, the UE 115-d may release or otherwise terminate the COT after the first uplink message.

At 625, the UE 115-d may resume the COT for a second uplink message in accordance with a second channel access type based on whether the second channel access type is present in the set of one or more channel access types. For example, the UE 115-d may support the second feature upgrade for upgrading from the first channel access type to either the first candidate channel access type (e.g., Type 2 channel access) or the second candidate channel access type (e.g., Type 3 channel access) based on which of the first candidate channel access type or the second candidate channel access type is present in the set of one or more channel access types (if not both).

For example, the UE 115-d may resume the COT in accordance with the first candidate channel access type if the first candidate channel access type is included in the set of one or more channel access types or if the second candidate channel access type is excluded from the set of one or more channel access types. Alternatively, the UE 115-c may resume the COT in accordance with the second candidate channel access type if the second candidate channel access type is included in the set of one or more channel access types or if the first candidate channel access type is excluded from the set of one or more channel access types. If both the first candidate channel access type and the second candidate channel access type are present or included in the set of one or more channel access types, the UE 115 may select one of the first candidate channel access type or the second candidate channel access type in accordance with a predefined rule. For example, if the first candidate channel access type (e.g., Type 2 channel access) is present, the UE 115 may select to use the first candidate channel access type (regardless of whether the second candidate channel access type is present).

At 630, the UE 115-d may transmit the second uplink message to the network entity 105-d during a resumption of the COT. In other words, the UE 115-d may transmit, during the resumption of the COT and based on whether the second channel access type (e.g., the first candidate channel access type or the second candidate channel access type) is present in the set of one or more channel access types.

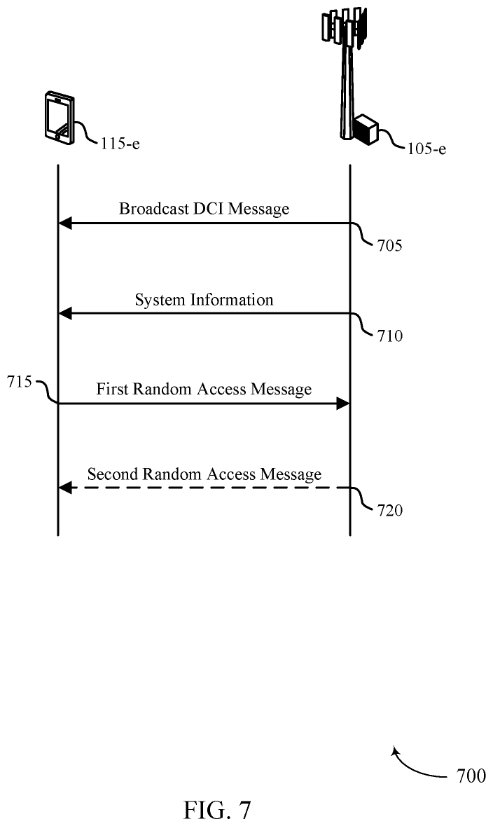

FIG. 7 illustrates an example of a process flow 700 that supports control mechanisms for uplink channel access types in accordance with one or more aspects of the present disclosure. The process flow 700 may implement or be implemented by aspects of the wireless communications system 100, the wireless communications system 200, and the communication timeline 400. For example, the process flow 700 illustrates communication between a UE 115-e and a network entity 105-e, which may be examples of corresponding devices as illustrated by and described with reference to FIGS. 1 and 2. In some implementations, the UE 115-e may support the third feature upgrade associated with channel access based on whether the UE 115-e is allowed to use contention-exempt short control signaling for one or more random access transmissions.

In the following description of the process flow 700, the operations may be performed (e.g., reported or provided) in a different order than the order shown, or the operations performed by the example devices may be performed in different orders or at different times. Some operations also may be left out of the process flow 700, or other operations may be added to the process flow 700. Further, although some operations or signaling may be shown to occur at different times for discussion purposes, these operations may actually occur at the same time. Further, although communication is illustrated by and described in the context of the process flow 700 as being performed between a UE 115 and a network entity 105, such communication may be performed between any two or more devices. For example, the described communication may be performed between a first network node and a second network node.

At 705, the UE 115-e may receive, from the network entity 105-e, a first broadcast DCI message that schedules a set of resources for reception of system information (e.g., RMSI) and that indicates a first channel access type for a first random access message (e.g., a msg1 or msgA transmission). In some aspects, the broadcast DCI message may be associated with a DCI format 1_0 with CRC scrambled by an SI-RNTI and may include a channel access control field that includes the indication of the first channel access type.

In some implementations, the channel access control field may indicate that the UE 115-e is to skip an LBT procedure for the first random access message. For example, if the channel access control field indicates a first candidate channel access type (e.g., Type 1 channel access), the UE 115-e may determine to perform an LBT procedure for the first random access message. In such examples, the UE 115-e may use contention-based signaling for the first random access message. In some other implementations, the channel access control field may indicate that the UE 115-e is to perform an LBT procedure for the first random access message. For example, if the channel access control field indicates a second candidate channel access type (e.g., Type 3 channel access), the UE 115-e may determine to skip an LBT procedure for the first random access message. In such examples, the UE 115-e may use contention-exempt signaling for the first random access message.

At 710, the UE 115-e may receive, from the network entity 105-e, system information (e.g., RMSI) over the set of resources indicated by the first broadcast DCI message. In some aspects, the UE 115-e may receive one or more parameters via the system information and may use the one or more parameters for the first random access message.

At 715, the UE 115-e may transmit, to the network entity 105-e, the first random access message using either contention-based signaling or contention-exempt signaling (e.g., contention-exempt short control signaling) based on the indication received via the first broadcast DCI message. In some aspects, the UE 115-e may transmit the first random access message in accordance with one or more parameters obtained from the system information.

At 720, the UE 115-e may receive, from the network entity 105-e, a second random access message responsive to the first random access message. The second random access message may be an example of a msg2 (e.g., if the UE 115-e and the network entity 105-e participate in a four-step random access procedure) or may be an example of a msgB (e.g., if the UE 115-e and the network entity 105-e participate in a two-step random access procedure).

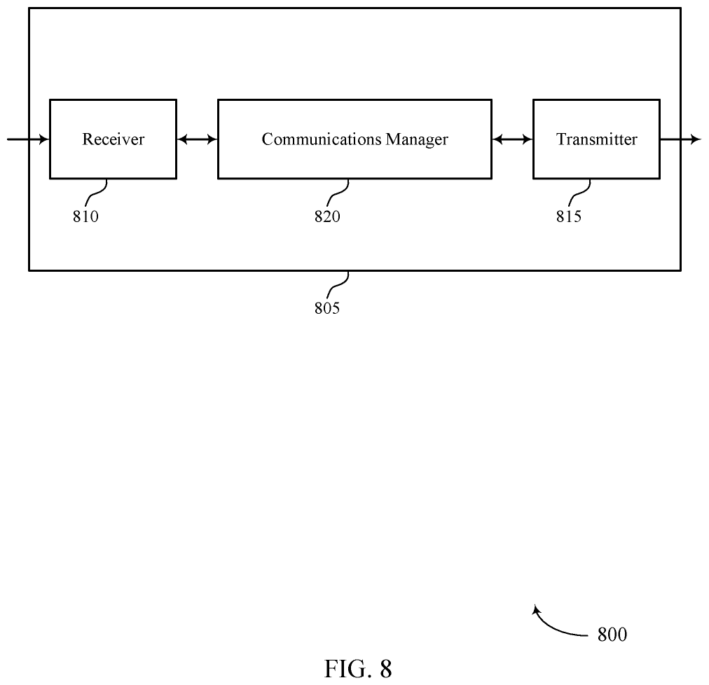

FIG. 8 shows a block diagram 800 of a device 805 that supports control mechanisms for uplink channel access types in accordance with one or more aspects of the present disclosure. The device 805 may be an example of aspects of a UE 115 as described herein. The device 805 may include a receiver 810, a transmitter 815, and a communications manager 820. The device 805 also may include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to control mechanisms for uplink channel access types). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to control mechanisms for uplink channel access types). In some implementations, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of control mechanisms for uplink channel access types as described herein. For example, the communications manager 820, the receiver 810, the transmitter 815, or various combinations or components thereof may support a method for performing one or more of the functions described herein.

In some implementations, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some implementations, a processor and memory coupled with the processor may be configured to perform one or more of the functions described herein (e.g., by executing, by the processor, instructions stored in the memory).

Additionally, or alternatively, in some aspects, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some implementations, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first network node in accordance with examples as disclosed herein. For example, the communications manager 820 may be configured as or otherwise support a means for receiving, from a second network node, a control message that indicates a set of one or more channel access types that are available to the first network node for communications between the first network node and the second network node. The communications manager 820 may be configured as or otherwise support a means for receiving, from the second network node, a first DCI message that schedules an uplink message from the first network node and indicates, for the uplink message, a first channel access type from the set of one or more channel access types. The communications manager 820 may be configured as or otherwise support a means for transmitting, during a COT of the second network node and based on whether a second channel access type is present in the set of one or more channel access types indicated by the control message, the uplink message in accordance with the second channel access type, where the second channel access type is different from the first channel access type.

Additionally, or alternatively, the communications manager 820 may support wireless communication at first network node in accordance with examples as disclosed herein. For example, the communications manager 820 may be configured as or otherwise support a means for receiving, from a second network node, a control message that indicates a set of one or more channel access types that are available to the first network node for communications between the first network node and the second network node. The communications manager 820 may be configured as or otherwise support a means for transmitting, during a COT obtained via a first channel access type, a first uplink message within a threshold COT associated with the first uplink message, where the COT is released after the first uplink message. The communications manager 820 may be configured as or otherwise support a means for transmitting, during a resumption of the COT and based on whether a second channel access type is present in the set of one or more channel access types, a second uplink message in accordance with the second channel access type, where the second channel access type is different from the first channel access type.

Additionally, or alternatively, the communications manager 820 may support wireless communication at a first network node in accordance with examples as disclosed herein. For example, the communications manager 820 may be configured as or otherwise support a means for receiving, from a second network node, a first broadcast DCI message that schedules a set of resources for reception of system information and that indicates a first channel access type for a first random access message. The communications manager 820 may be configured as or otherwise support a means for transmitting, to the second network node, the first random access message in accordance with a channel access procedure that is based on the first channel access type indicated by the first broadcast DCI message.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for reduced processing, reduced power consumption, and more efficient utilization of communication resources.

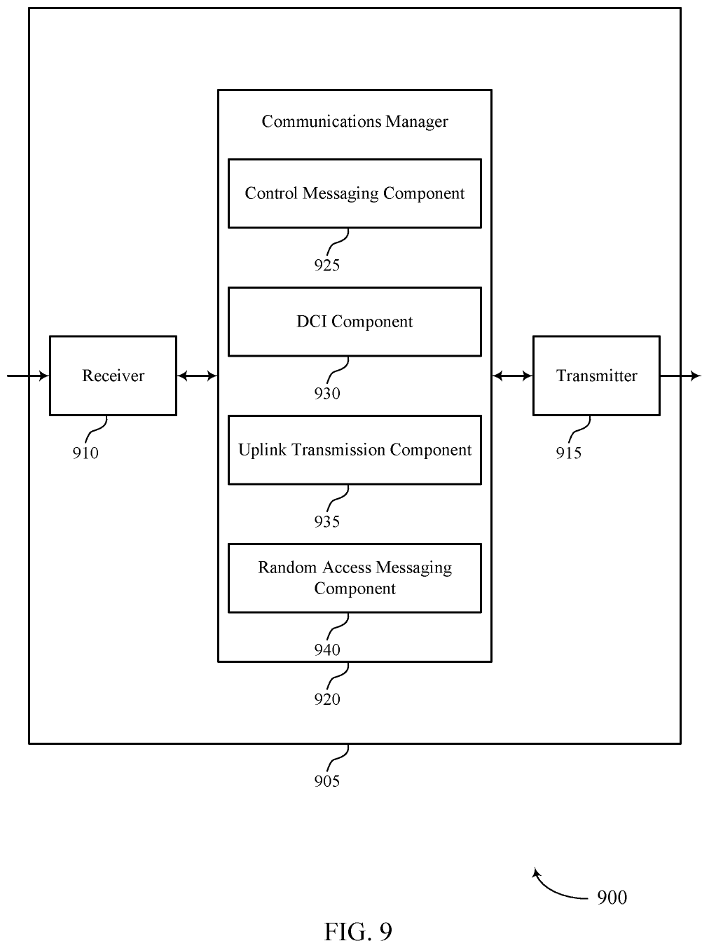

FIG. 9 shows a block diagram 900 of a device 905 that supports control mechanisms for uplink channel access types in accordance with one or more aspects of the present disclosure. The device 905 may be an example of aspects of a device 805 or a UE 115 as described herein. The device 905 may include a receiver 910, a transmitter 915, and a communications manager 920. The device 905 also may include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to control mechanisms for uplink channel access types). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to control mechanisms for uplink channel access types). In some implementations, the transmitter 915 may be co-located with a receiver 910 in a transceiver module. The transmitter 915 may utilize a single antenna or a set of multiple antennas.

The device 905, or various components thereof, may be an example of means for performing various aspects of control mechanisms for uplink channel access types as described herein. For example, the communications manager 920 may include a control messaging component 925, a DCI component 930, an uplink transmission component 935, a random access messaging component 940, or any combination thereof. The communications manager 920 may be an example of aspects of a communications manager 820 as described herein. In some implementations, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a first network node in accordance with examples as disclosed herein. The control messaging component 925 may be configured as or otherwise support a means for receiving, from a second network node, a control message that indicates a set of one or more channel access types that are available to the first network node for communications between the first network node and the second network node. The DCI component 930 may be configured as or otherwise support a means for receiving, from the second network node, a first DCI message that schedules an uplink message from the first network node and indicates, for the uplink message, a first channel access type from the set of one or more channel access types. The uplink transmission component 935 may be configured as or otherwise support a means for transmitting, during a COT of the second network node and based on whether a second channel access type is present in the set of one or more channel access types indicated by the control message, the uplink message in accordance with the second channel access type, where the second channel access type is different from the first channel access type.

Additionally, or alternatively, the communications manager 920 may support wireless communication at first network node in accordance with examples as disclosed herein. The control messaging component 925 may be configured as or otherwise support a means for receiving, from a second network node, a control message that indicates a set of one or more channel access types that are available to the first network node for communications between the first network node and the second network node. The uplink transmission component 935 may be configured as or otherwise support a means for transmitting, during a COT obtained via a first channel access type, a first uplink message within a threshold COT associated with the first uplink message, where the COT is released after the first uplink message. The uplink transmission component 935 may be configured as or otherwise support a means for transmitting, during a resumption of the COT and based on whether a second channel access type is present in the set of one or more channel access types, a second uplink message in accordance with the second channel access type, where the second channel access type is different from the first channel access type.

Additionally, or alternatively, the communications manager 920 may support wireless communication at a first network node in accordance with examples as disclosed herein. The DCI component 930 may be configured as or otherwise support a means for receiving, from a second network node, a first broadcast DCI message that schedules a set of resources for reception of system information and that indicates a first channel access type for a first random access message. The random access messaging component 940 may be configured as or otherwise support a means for transmitting, to the second network node, the first random access message in accordance with a channel access procedure that is based on the first channel access type indicated by the first broadcast DCI message.

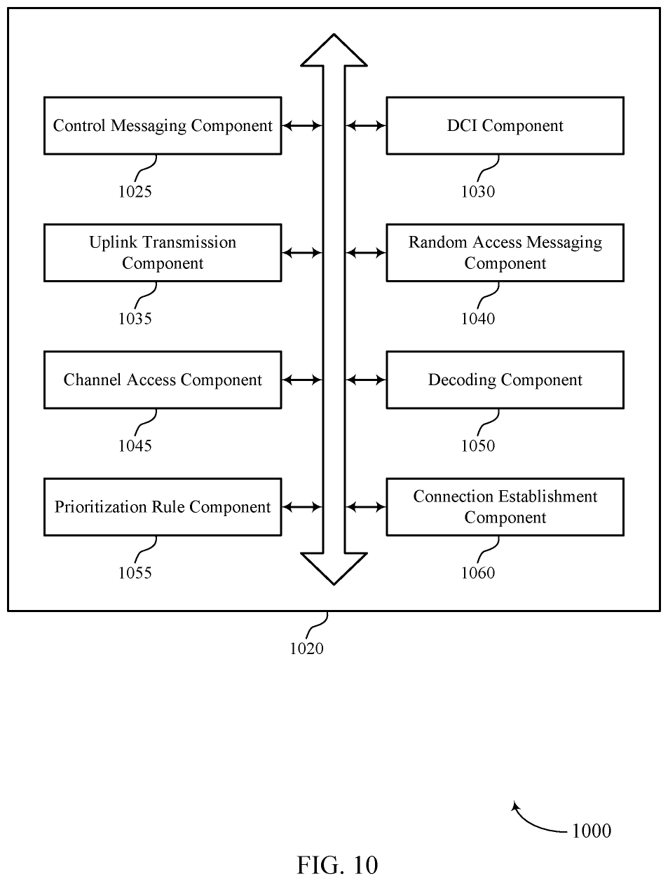

FIG. 10 shows a block diagram 1000 of a communications manager 1020 that supports control mechanisms for uplink channel access types in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of control mechanisms for uplink channel access types as described herein. For example, the communications manager 1020 may include a control messaging component 1025, a DCI component 1030, an uplink transmission component 1035, a random access messaging component 1040, a channel access component 1045, a decoding component 1050, a prioritization rule component 1055, a connection establishment component 1060, or any combination thereof. Each of these components may communicate, directly or indirectly, with one another (e.g., via one or more buses).

The communications manager 1020 may support wireless communication at a first network node in accordance with examples as disclosed herein. The control messaging component 1025 may be configured as or otherwise support a means for receiving, from a second network node, a control message that indicates a set of one or more channel access types that are available to the first network node for communications between the first network node and the second network node. The DCI component 1030 may be configured as or otherwise support a means for receiving, from the second network node, a first DCI message that schedules an uplink message from the first network node and indicates, for the uplink message, a first channel access type from the set of one or more channel access types. The uplink transmission component 1035 may be configured as or otherwise support a means for transmitting, during a COT of the second network node and based on whether a second channel access type is present in the set of one or more channel access types indicated by the control message, the uplink message in accordance with the second channel access type, where the second channel access type is different from the first channel access type.

In some implementations, the set of one or more channel access types that are available to the first network node includes the first channel access type and at least one of a first candidate channel access type or a second candidate channel access type. In some implementations, the second channel access type is one of the first candidate channel access type or the second candidate channel access type.

In some implementations, to support transmitting the uplink message in accordance with the second channel access type, the uplink transmission component 1035 may be configured as or otherwise support a means for transmitting the uplink message during the COT of the second network node in accordance with the first candidate channel access type based on the first candidate channel access type being present in the set of one or more channel access types or based on the second candidate channel access type being excluded from the set of one or more channel access types.

In some implementations, to support transmitting the uplink message in accordance with the second channel access type, the uplink transmission component 1035 may be configured as or otherwise support a means for transmitting the uplink message during the COT of the second network node in accordance with the second candidate channel access type based on the second candidate channel access type being present in the set of one or more channel access types or based on the first candidate channel access type being excluded from the set of one or more channel access types.

In some implementations, the first channel access type includes one or more channel sensing operations associated with a channel sensing count prior to occupation of a channel between the first network node and the second network node. In some implementations, the first candidate channel access type includes a single channel sensing operation prior to occupation of the channel. In some implementations, the second candidate channel access type excludes channel sensing operations prior to occupation of the channel.

In some implementations, each respective channel sensing operation is a respective LBT operation.

In some implementations, the control message indicates a mapping between each respective permutation of a set of multiple permutations of a set of one or more bits and each respective channel access type of the set of one or more channel access types.

In some implementations, the first DCI message includes a first permutation of the plurality of permutations of the set of one or more bits, and the first permutation maps to the first channel access type in accordance with the mapping.

In some implementations, the first DCI message includes a channel access control field including the first permutation.

In some implementations, the second channel access type is present in the set of one or more channel access types if at least one permutation of the set of multiple permutations maps to the second channel access type in accordance with the mapping.

In some implementations, the control message indicates a first mapping between each respective permutation of a set of multiple permutations of a set of one or more bits and each respective channel access type of a first set of one or more channel access types. In some implementations, the control message indicates a second mapping between each respective permutation of the set of multiple permutations of the set of one or more bits and each respective channel access type of a second set of one or more channel access types. In some implementations, the set of one or more channel access types includes the first set of one or more channel access types and the second set of one or more channel access types.

In some implementations, the first DCI message includes a first permutation of the plurality of permutations of the set of one or more bits, and the first permutation maps to the first channel access type in accordance with the mapping.

In some implementations, the first DCI message includes a channel access control field including the first permutation.

In some implementations, the first mapping is associated with DCI messages that schedule uplink communication. In some implementations, the second mapping is associated with DCI messages that schedule downlink communication.

In some implementations, the second channel access type is present in the set of one or more channel access types if at least one permutation of the set of multiple permutations maps to the second channel access type in accordance with the first mapping or the second mapping.

In some implementations, the second channel access type is present in the set of one or more channel access types if at least one first permutation of the set of multiple permutations maps to the second channel access type in accordance with the first mapping and at least one second permutation of the set of multiple permutations maps to the second channel access type in accordance with the second mapping.

In some implementations, the second channel access type is present in the set of one or more channel access types if at least one permutation of the set of multiple permutations maps to the second channel access type in accordance with the first mapping.

In some implementations, the second channel access type is present in the set of one or more channel access types if at least one permutation of the set of multiple permutations maps to the second channel access type in accordance with the second mapping.

In some implementations, the DCI component 1030 may be configured as or otherwise support a means for receiving, from the second network node, a second DCI message that indicates a slot format, where the slot format indicates the COT of the second network node, and where the uplink message is transmitted in accordance with the second channel access type based on the slot format.

In some implementations, the slot format indicates a starting time and a duration of the COT of the second network node.

In some implementations, the control message that indicates the set of one or more channel access types enables or disables an upgrade, for the uplink message, from the first channel access type to the second channel access type during the COT of the second network node based on whether the second channel access type is present in the set of one or more channel access types.

In some implementations, a presence of the second channel access type in the set of one or more channel access types is based on a geographic location of the first network node.

Additionally, or alternatively, the communications manager 1020 may support wireless communication at first network node in accordance with examples as disclosed herein. In some implementations, the control messaging component 1025 may be configured as or otherwise support a means for receiving, from a second network node, a control message that indicates a set of one or more channel access types that are available to the first network node for communications between the first network node and the second network node. In some implementations, the uplink transmission component 1035 may be configured as or otherwise support a means for transmitting, during a COT obtained via a first channel access type, a first uplink message within a threshold COT associated with the first uplink message, where the COT is released after the first uplink message. In some implementations, the uplink transmission component 1035 may be configured as or otherwise support a means for transmitting, during a resumption of the COT and based on whether a second channel access type is present in the set of one or more channel access types, a second uplink message in accordance with the second channel access type, where the second channel access type is different from the first channel access type.

In some implementations, the set of one or more channel access types that are available to the first network node includes the first channel access type and at least one of a first candidate channel access type or a second candidate channel access type. In some implementations, the second channel access type is one of the first candidate channel access type or the second candidate channel access type.

In some implementations, to support transmitting the second uplink message in accordance with the second channel access type, the uplink transmission component 1035 may be configured as or otherwise support a means for transmitting the second uplink message during the resumption of the COT in accordance with the first candidate channel access type based on the first candidate channel access type being present in the set of one or more channel access types or based on the second candidate channel access type being excluded from the set of one or more channel access types.

In some implementations, to support transmitting the second uplink message in accordance with the second channel access type, the uplink transmission component 1035 may be configured as or otherwise support a means for transmitting the second uplink message during the resumption of the COT in accordance with the second candidate channel access type based on the second candidate channel access type being present in the set of one or more channel access types or based on the first candidate channel access type being excluded from the set of one or more channel access types.

In some implementations, the first channel access type includes one or more channel sensing operations associated with a channel sensing count prior to occupation of a channel between the first network node and the second network node. In some implementations, the first candidate channel access type includes a single channel sensing operation prior to occupation of the channel. In some implementations, the second candidate channel access type excludes channel sensing operations prior to occupation of the channel.

In some implementations, each respective channel sensing operation is a respective listen-before-talk operation.

In some implementations, the control message indicates a mapping between each respective permutation of a set of multiple permutations of a set of one or more bits and each respective channel access type of the set of one or more channel access types.

In some implementations, a DCI message that schedules the first uplink message includes a first permutation of the plurality of permutations of the set of one or more bits, and the first permutation maps to the first channel access type in accordance with the mapping.

In some implementations, the DCI message includes a channel access control field including the first permutation.

In some implementations, the second channel access type is present in the set of one or more channel access types if at least one permutation of the set of multiple permutations maps to the second channel access type in accordance with the mapping.

In some implementations, the control message indicates a first mapping between each respective permutation of a set of multiple permutations of a set of one or more bits and each respective channel access type of a first set of one or more channel access types. In some implementations, the control message indicates a second mapping between each respective permutation of the set of multiple permutations of the set of one or more bits and each respective channel access type of a second set of one or more channel access types. In some implementations, the set of one or more channel access types includes the first set of one or more channel access types and the second set of one or more channel access types.

In some implementations, a DCI message that schedules the first uplink message includes a first permutation of the plurality of permutations of the set of one or more bits, and the first permutation maps to the first channel access type in accordance with the first mapping.

In some implementations, the DCI message includes a channel access control field including the first permutation.

In some implementations, the first mapping is associated with DCI messages that schedule uplink communication. In some implementations, the second mapping is associated with DCI messages that schedule downlink communication.

In some implementations, the second channel access type is present in the set of one or more channel access types if at least one permutation of the set of multiple permutations maps to the second channel access type in accordance with the first mapping or the second mapping.

In some implementations, the second channel access type is present in the set of one or more channel access types if at least one first permutation of the set of multiple permutations maps to the second channel access type in accordance with the first mapping and at least one second permutation of the set of multiple permutations maps to the second channel access type in accordance with the second mapping.

In some implementations, the second channel access type is present in the set of one or more channel access types if at least one permutation of the set of multiple permutations maps to the second channel access type in accordance with the first mapping.

In some implementations, the second channel access type is present in the set of one or more channel access types if at least one permutation of the set of multiple permutations maps to the second channel access type in accordance with the second mapping.

In some implementations, the channel access component 1045 may be configured as or otherwise support a means for resuming the COT for the second uplink message in accordance with the second channel access type based on whether the second channel access type is present in the set of one or more channel access types, where the second uplink message is transmitted based on the resumption of the COT in accordance with the second channel access type.

In some implementations, the control message that indicates the set of one or more channel access types enables or disables an upgrade, for the second uplink message, from the first channel access type to the second channel access type during the resumption of the COT based on whether the second channel access type is present in the set of one or more channel access types.

In some implementations, a presence of the second channel access type in the set of one or more channel access types is based on a geographic location of the first network node.

Additionally, or alternatively, the communications manager 1020 may support wireless communication at a first network node in accordance with examples as disclosed herein. In some implementations, the DCI component 1030 may be configured as or otherwise support a means for receiving, from a second network node, a first broadcast DCI message that schedules a set of resources for reception of system information and that indicates a first channel access type for a first random access message. The random access messaging component 1040 may be configured as or otherwise support a means for transmitting, to the second network node, the first random access message in accordance with a channel access procedure that is based on the first channel access type indicated by the first broadcast DCI message.

In some implementations, the DCI component 1030 may be configured as or otherwise support a means for receiving information indicative of the first channel access type via a channel access control field of the first broadcast DCI message.

In some implementations, the first channel access type indicates that the first network node is to skip a listen-before-talk procedure for the first random access message or that the first network node is to perform the listen-before-talk procedure for the first random access message.

In some implementations, the first channel access type indicates one of a first candidate channel access type or a second candidate channel access type. In some implementations, the first candidate channel access type includes one or more channel sensing operations during a pendency of a countdown timer prior to occupation of a channel between the first network node and the second network node. In some implementations, the second candidate channel access type excludes channel sensing operations prior to occupation of a channel between the first network node and the second network node.

In some implementations, to support transmitting the first random access message, the random access messaging component 1040 may be configured as or otherwise support a means for transmitting the first random access message via contention-based signaling if the first network node is to use the first candidate channel access type for the first random access message. In some implementations, to support transmitting the first random access message, the random access messaging component 1040 may be configured as or otherwise support a means for transmitting the first random access message via contention-exempt signaling if the first network node is to use the second candidate channel access type for the first random access message.

In some implementations, the decoding component 1050 may be configured as or otherwise support a means for decoding the first broadcast DCI message based on a system information radio network identifier.

In some implementations, the DCI component 1030 may be configured as or otherwise support a means for receiving a second broadcast DCI that indicates a second channel access type for the first random access message, where the second channel access type is different from the first channel access type. In some implementations, the prioritization rule component 1055 may be configured as or otherwise support a means for ignoring the second channel access type for the first random access message in accordance with a configured rule.

In some implementations, the configured rule indicates that the second channel access type is to be ignored if the first channel access type is indicated for the first random access message.

In some implementations, the configured rule indicates that the second channel access type is to be ignored if the first channel access type includes one or more channel sensing operations associated with a channel sensing count prior to occupation of a channel between the first network node and the second network node.

In some implementations, the configured rule indicates that the second channel access type is to be ignored if the first channel access type excludes channel sensing operations prior to occupation of a channel between the first network node and the second network node.

In some implementations, the first broadcast DCI message that indicates the first channel access type for the first random access message enables or disables an upgrade, for the first random access message, from contention-based signaling to contention-exempt signaling based on the first channel access type.

In some implementations, the random access messaging component 1040 may be configured as or otherwise support a means for receive, from the second network node, a second random access message responsive to the first random access message. In some implementations, the connection establishment component 1060 may be configured as or otherwise support a means for establish a connection between the first network node and the second network node based on the first random access message and the second random access message.

In some implementations, the first channel access type is based on a geographic location of the first network node.

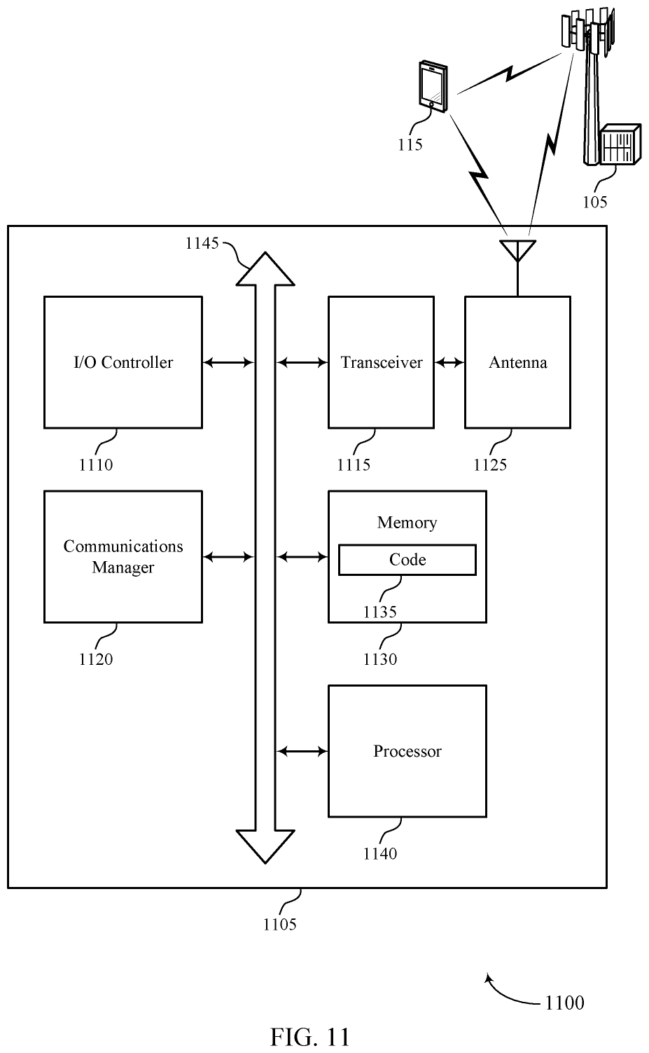

FIG. 11 shows a diagram of a system 1100 including a device 1105 that supports control mechanisms for uplink channel access types in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 also may manage peripherals not integrated into the device 1105. In some implementations, the I/O controller 1110 may represent a physical connection or port to an external peripheral. In some implementations, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some implementations, the I/O controller 1110 may be implemented as part of a processor, such as the processor 1140. In some implementations, a user may interact with the device 1105 via the I/O controller 1110 or via hardware components controlled by the I/O controller 1110.

In some implementations, the device 1105 may include a single antenna 1125. However, in some other implementations, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 also may include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some implementations, the code 1135 may not be directly executable by the processor 1140 but may cause a computer (e.g., when compiled and executed) to perform functions described herein. In some implementations, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1140 may be configured to operate a memory array using a memory controller. In some other implementations, a memory controller may be integrated into the processor 1140. The processor 1140 may be configured to execute computer-readable instructions stored in a memory (e.g., the memory 1130) to cause the device 1105 to perform various functions (e.g., functions or tasks supporting control mechanisms for uplink channel access types). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a first network node in accordance with examples as disclosed herein. For example, the communications manager 1120 may be configured as or otherwise support a means for receiving, from a second network node, a control message that indicates a set of one or more channel access types that are available to the first network node for communications between the first network node and the second network node. The communications manager 1120 may be configured as or otherwise support a means for receiving, from the second network node, a first DCI message that schedules an uplink message from the first network node and indicates, for the uplink message, a first channel access type from the set of one or more channel access types. The communications manager 1120 may be configured as or otherwise support a means for transmitting, during a COT of the second network node and based on whether a second channel access type is present in the set of one or more channel access types indicated by the control message, the uplink message in accordance with the second channel access type, where the second channel access type is different from the first channel access type.

Additionally, or alternatively, the communications manager 1120 may support wireless communication at first network node in accordance with examples as disclosed herein. For example, the communications manager 1120 may be configured as or otherwise support a means for receiving, from a second network node, a control message that indicates a set of one or more channel access types that are available to the first network node for communications between the first network node and the second network node. The communications manager 1120 may be configured as or otherwise support a means for transmitting, during a COT obtained via a first channel access type, a first uplink message within a threshold COT associated with the first uplink message, where the COT is released after the first uplink message. The communications manager 1120 may be configured as or otherwise support a means for transmitting, during a resumption of the COT and based on whether a second channel access type is present in the set of one or more channel access types, a second uplink message in accordance with the second channel access type, where the second channel access type is different from the first channel access type.

Additionally, or alternatively, the communications manager 1120 may support wireless communication at a first network node in accordance with examples as disclosed herein. For example, the communications manager 1120 may be configured as or otherwise support a means for receiving, from a second network node, a first broadcast DCI message that schedules a set of resources for reception of system information and that indicates a first channel access type for a first random access message. The communications manager 1120 may be configured as or otherwise support a means for transmitting, to the second network node, the first random access message in accordance with a channel access procedure that is based on the first channel access type indicated by the first broadcast DCI message.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, and improved utilization of processing capability.

In some implementations, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some aspects, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of control mechanisms for uplink channel access types as described herein, or the processor 1140 and the memory 1130 may be otherwise configured to perform or support such operations.

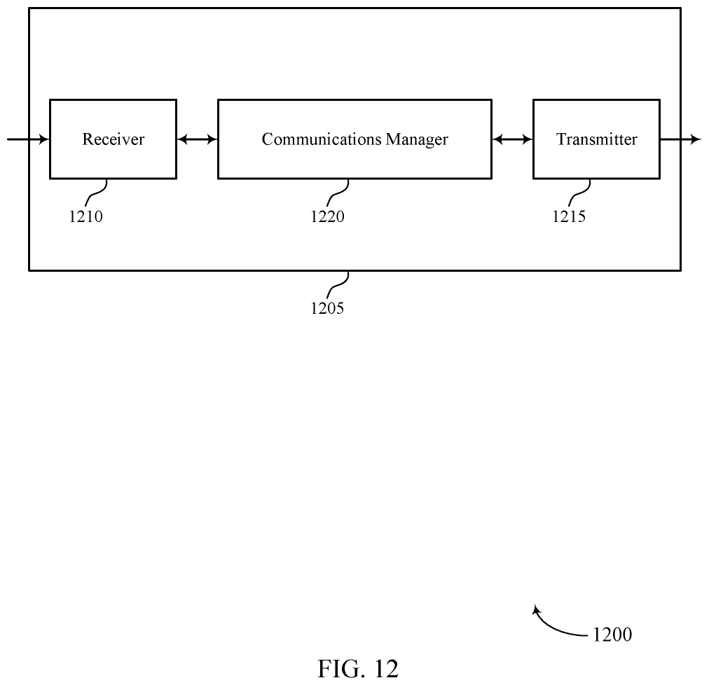

FIG. 12 shows a block diagram 1200 of a device 1205 that supports control mechanisms for uplink channel access types in accordance with one or more aspects of the present disclosure. The device 1205 may be an example of aspects of a network entity 105 as described herein. The device 1205 may include a receiver 1210, a transmitter 1215, and a communications manager 1220. The device 1205 also may include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some implementations, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some implementations, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some implementations, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of control mechanisms for uplink channel access types as described herein. For example, the communications manager 1220, the receiver 1210, the transmitter 1215, or various combinations or components thereof may support a method for performing one or more of the functions described herein.

In some implementations, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some implementations, a processor and memory coupled with the processor may be configured to perform one or more of the functions described herein (e.g., by executing, by the processor, instructions stored in the memory).

Additionally, or alternatively, in some aspects, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some implementations, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a first network node in accordance with examples as disclosed herein. For example, the communications manager 1220 may be configured as or otherwise support a means for transmitting, to a second network node, a first broadcast DCI message that schedules a set of resources for transmission of system information and that indicates a first channel access type for a first random access message. The communications manager 1220 may be configured as or otherwise support a means for receiving, from the second network node, the first random access message in accordance with a channel access procedure that is based on the first channel access type indicated by the first broadcast DCI message.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for reduced processing, reduced power consumption, and more efficient utilization of communication resources.

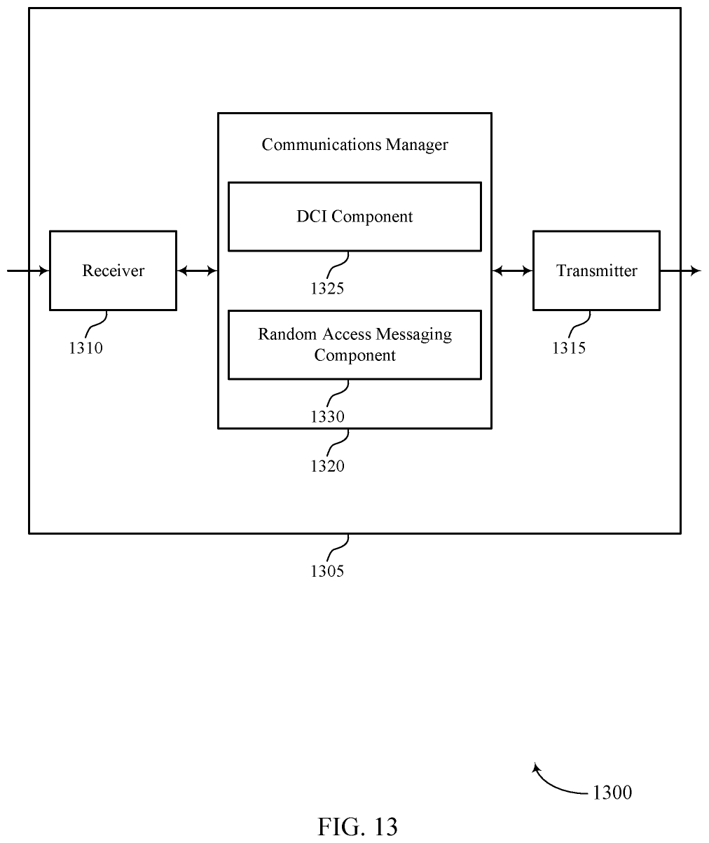

FIG. 13 shows a block diagram 1300 of a device 1305 that supports control mechanisms for uplink channel access types in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305 also may include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some implementations, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some implementations, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some implementations, the transmitter 1315 and the receiver 1310 may be co-located in a transceiver, which may include or be coupled with a modem.

The device 1305, or various components thereof, may be an example of means for performing various aspects of control mechanisms for uplink channel access types as described herein. For example, the communications manager 1320 may include a DCI component 1325 a random access messaging component 1330, or any combination thereof. The communications manager 1320 may be an example of aspects of a communications manager 1220 as described herein. In some implementations, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a first network node in accordance with examples as disclosed herein. The DCI component 1325 may be configured as or otherwise support a means for transmitting, to a second network node, a first broadcast DCI message that schedules a set of resources for transmission of system information and that indicates a first channel access type for a first random access message. The random access messaging component 1330 may be configured as or otherwise support a means for receiving, from the second network node, the first random access message in accordance with a channel access procedure that is based on the first channel access type indicated by the first broadcast DCI message.

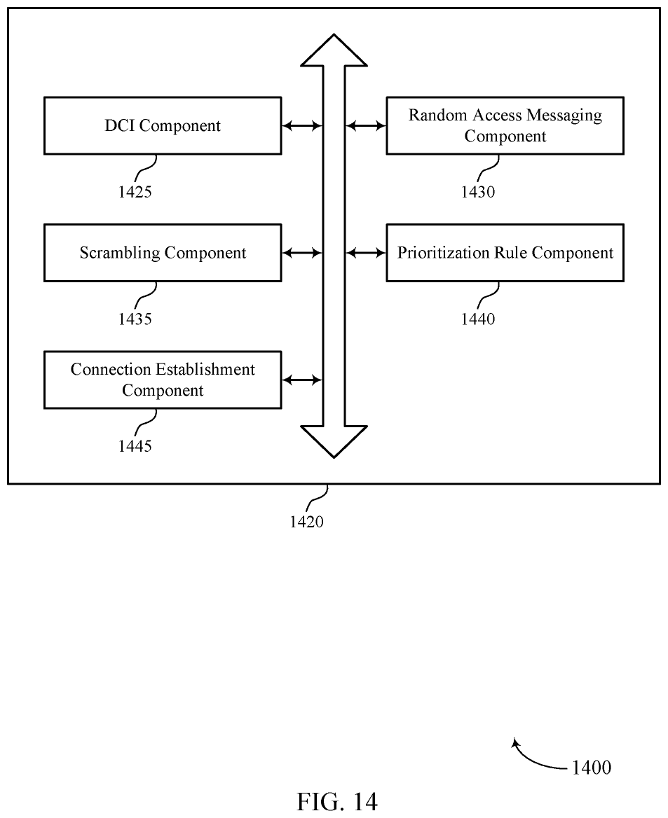

FIG. 14 shows a block diagram 1400 of a communications manager 1420 that supports control mechanisms for uplink channel access types in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of control mechanisms for uplink channel access types as described herein. For example, the communications manager 1420 may include a DCI component 1425, a random access messaging component 1430, a scrambling component 1435, a prioritization rule component 1440, a connection establishment component 1445, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communication at a first network node in accordance with examples as disclosed herein. The DCI component 1425 may be configured as or otherwise support a means for transmitting, to a second network node, a first broadcast DCI message that schedules a set of resources for transmission of system information and that indicates a first channel access type for a first random access message. The random access messaging component 1430 may be configured as or otherwise support a means for receiving, from the second network node, the first random access message in accordance with a channel access procedure that is based on the first channel access type indicated by the first broadcast DCI message.

In some implementations, the DCI component 1425 may be configured as or otherwise support a means for transmitting information indicative of the first channel access type via a channel access control field of the first broadcast DCI message.

In some implementations, the first channel access type indicates that the second network node is to skip a listen-before-talk procedure for the first random access message or that the second network node is to perform the listen-before-talk procedure for the first random access message.

In some implementations, the first channel access type indicates one of a first candidate channel access type or a second candidate channel access type. In some implementations, the first candidate channel access type includes one or more channel sensing operations during a pendency of a countdown timer prior to occupation of a channel between the first network node and the second network node. In some implementations, the second candidate channel access type excludes channel sensing operations prior to occupation of a channel between the first network node and the second network node.

In some implementations, to support receiving the first random access message, the random access messaging component 1430 may be configured as or otherwise support a means for receiving the first random access message via contention-based signaling if the second network node is to use the first candidate channel access type for the first random access message. In some implementations, to support receiving the first random access message, the random access messaging component 1430 may be configured as or otherwise support a means for receiving the first random access message via contention-exempt signaling if the second network node is to use the second candidate channel access type for the first random access message.

In some implementations, the scrambling component 1435 may be configured as or otherwise support a means for scrambling the first broadcast DCI message based on a system information radio network identifier.

In some implementations, the DCI component 1425 may be configured as or otherwise support a means for transmitting a second broadcast DCI that indicates a second channel access type for the first random access message, where the second channel access type is different from the first channel access type. In some implementations, the prioritization rule component 1440 may be configured as or otherwise support a means for ignoring the second channel access type for the first random access message in accordance with a configured rule.

In some implementations, the configured rule indicates that the second channel access type is to be ignored if the first channel access type is indicated for the first random access message.

In some implementations, the configured rule indicates that the second channel access type is to be ignored if the first channel access type includes one or more channel sensing operations associated with a channel sensing count prior to occupation of a channel between the first network node and the second network node.

In some implementations, the configured rule indicates that the second channel access type is to be ignored if the first channel access type excludes channel sensing operations prior to occupation of a channel between the first network node and the second network node.

In some implementations, the first broadcast DCI message that indicates the first channel access type for the first random access message enables or disables an upgrade, for the first random access message, from contention-based signaling to contention-exempt signaling based on the first channel access type.

In some implementations, the random access messaging component 1430 may be configured as or otherwise support a means for transmitting, to the second network node, a second random access message responsive to the first random access message. In some implementations, the connection establishment component 1445 may be configured as or otherwise support a means for establishing a connection between the first network node and the second network node based on the first random access message and the second random access message.

In some implementations, the first channel access type is based on a geographic location of the first network node.

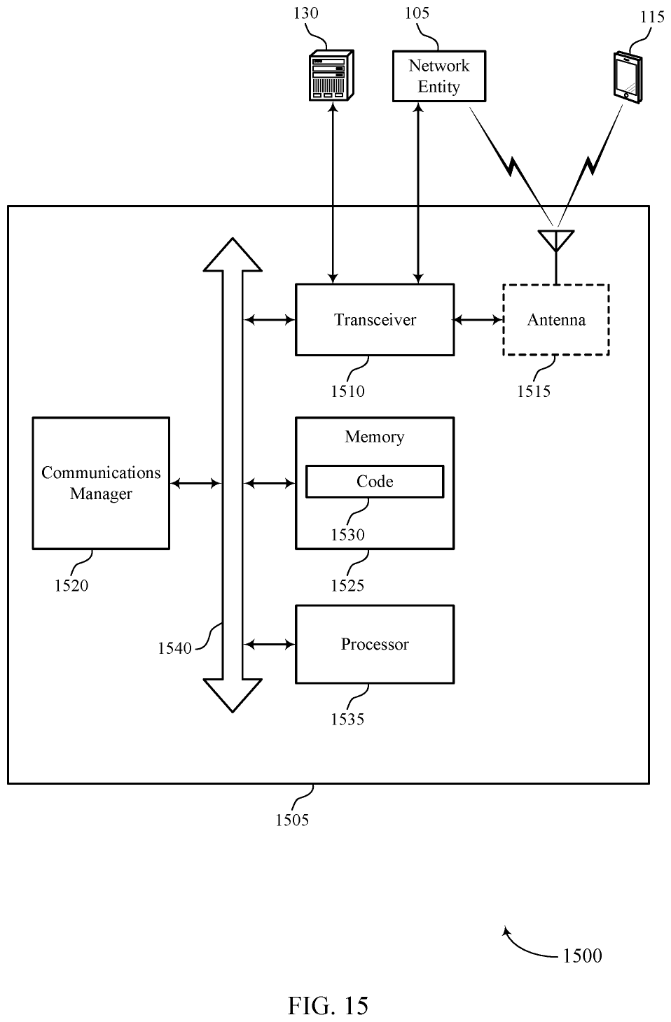

FIG. 15 shows a diagram of a system 1500 including a device 1505 that supports control mechanisms for uplink channel access types in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some implementations, the transceiver 1510 may include a wired transceiver and may communicate bi-directionally with another wired transceiver. Additionally, or alternatively, in some aspects, the transceiver 1510 may include a wireless transceiver and may communicate bi-directionally with another wireless transceiver. In some implementations, the device 1505 may include one or more antennas 1515, which may be capable of transmitting or receiving wireless transmissions (e.g., concurrently). The transceiver 1510 also may include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. The transceiver 1510, or the transceiver 1510 and one or more antennas 1515 or wired interfaces, where applicable, may be an example of a transmitter 1215, a transmitter 1315, a receiver 1210, a receiver 1310, or any combination thereof or component thereof, as described herein. In some implementations, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some implementations, the code 1530 may not be directly executable by the processor 1535 but may cause a computer (e.g., when compiled and executed) to perform functions described herein. In some implementations, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some implementations, the processor 1535 may be configured to operate a memory array using a memory controller. In some other implementations, a memory controller may be integrated into the processor 1535. The processor 1535 may be configured to execute computer-readable instructions stored in a memory (e.g., the memory 1525) to cause the device 1505 to perform various functions (e.g., functions or tasks supporting control mechanisms for uplink channel access types). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505.

In some implementations, a bus 1540 may support communications of (e.g., within) a protocol layer of a protocol stack. In some implementations, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some implementations, the communications manager 1520 may manage aspects of communications with a core network 130 (e.g., via one or more wired or wireless backhaul links). For example, the communications manager 1520 may manage the transfer of data communications for client devices, such as one or more UEs 115. In some implementations, the communications manager 1520 may manage communications with other network entities 105, and may include a controller or scheduler for controlling communications with UEs 115 in cooperation with other network entities 105. In some implementations, the communications manager 1520 may support an X2 interface within an LTE/LTE-A wireless communications network technology to provide communication between network entities 105.

The communications manager 1520 may support wireless communication at a first network node in accordance with examples as disclosed herein. For example, the communications manager 1520 may be configured as or otherwise support a means for transmitting, to a second network node, a first broadcast DCI message that schedules a set of resources for transmission of system information and that indicates a first channel access type for a first random access message. The communications manager 1520 may be configured as or otherwise support a means for receiving, from the second network node, the first random access message in accordance with a channel access procedure that is based on the first channel access type indicated by the first broadcast DCI message.

By including or configuring the communications manager 1520 in accordance with examples as described herein, the device 1505 may support techniques for improved communication reliability, reduced latency, improved user experience related to reduced processing, reduced power consumption, more efficient utilization of communication resources, improved coordination between devices, longer battery life, and improved utilization of processing capability.

In some implementations, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some aspects, one or more functions described with reference to the communications manager 1520 may be supported by or performed by the processor 1535, the memory 1525, the code 1530, the transceiver 1510, or any combination thereof. For example, the code 1530 may include instructions executable by the processor 1535 to cause the device 1505 to perform various aspects of control mechanisms for uplink channel access types as described herein, or the processor 1535 and the memory 1525 may be otherwise configured to perform or support such operations.

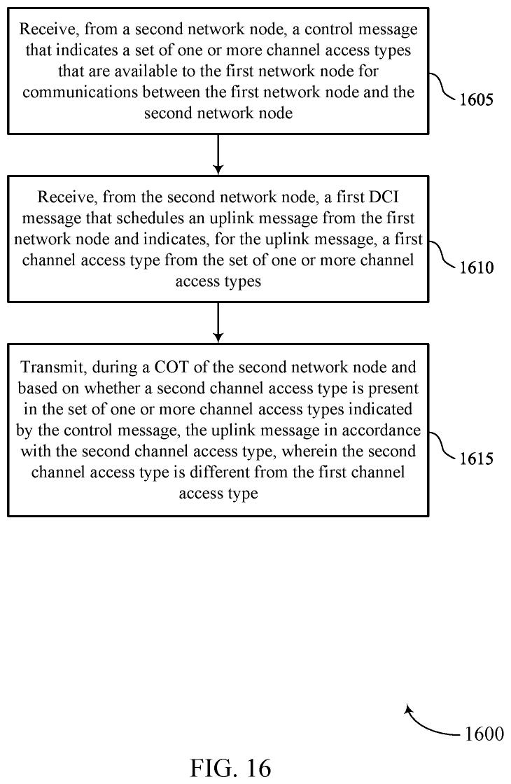

FIG. 16 shows a flowchart illustrating a method 1600 that supports control mechanisms for uplink channel access types in accordance with one or more aspects of the present disclosure. The operations of the method 1600 may be implemented by a UE or its components as described herein. For example, the operations of the method 1600 may be performed by a UE 115 as described with reference to FIGS. 1 through 11. In some implementations, a UE may execute a set of instructions to control the functional elements of the UE to perform the described functions. Additionally, or alternatively, the UE may perform aspects of the described functions using special-purpose hardware.

At 1605, the method may include receiving, from a second network node, a control message that indicates a set of one or more channel access types that are available to the first network node for communications between the first network node and the second network node. The operations of 1605 may be performed in accordance with examples as disclosed herein. In some implementations, aspects of the operations of 1605 may be performed by a control messaging component 1025 as described with reference to FIG. 10.

At 1610, the method may include receiving, from the second network node, a first DCI message that schedules an uplink message from the first network node and indicates, for the uplink message, a first channel access type from the set of one or more channel access types. The operations of 1610 may be performed in accordance with examples as disclosed herein. In some implementations, aspects of the operations of 1610 may be performed by a DCI component 1030 as described with reference to FIG. 10.

At 1615, the method may include transmitting, during a COT of the second network node and based on whether a second channel access type is present in the set of one or more channel access types indicated by the control message, the uplink message in accordance with the second channel access type, where the second channel access type is different from the first channel access type. The operations of 1615 may be performed in accordance with examples as disclosed herein. In some implementations, aspects of the operations of 1615 may be performed by an uplink transmission component 1035 as described with reference to FIG. 10.

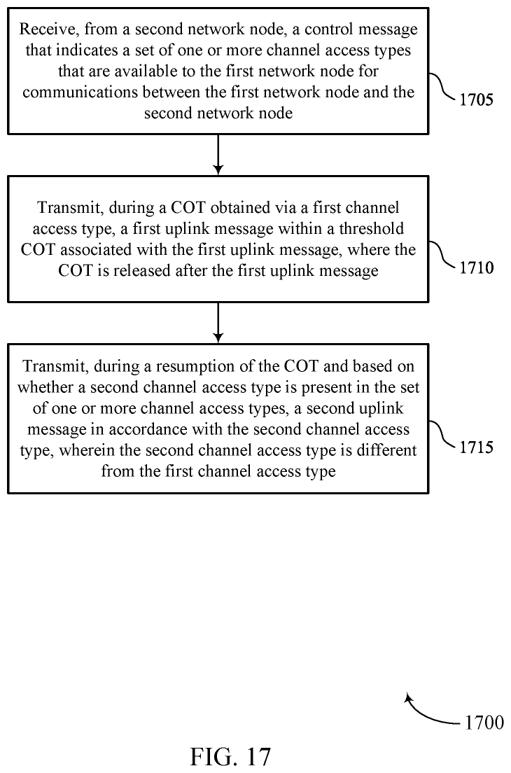

FIG. 17 shows a flowchart illustrating a method 1700 that supports control mechanisms for uplink channel access types in accordance with one or more aspects of the present disclosure. The operations of the method 1700 may be implemented by a UE or its components as described herein. For example, the operations of the method 1700 may be performed by a UE 115 as described with reference to FIGS. 1 through 11. In some implementations, a UE may execute a set of instructions to control the functional elements of the UE to perform the described functions. Additionally, or alternatively, the UE may perform aspects of the described functions using special-purpose hardware.

At 1705, the method may include receiving, from a second network node, a control message that indicates a set of one or more channel access types that are available to the first network node for communications between the first network node and the second network node. The operations of 1705 may be performed in accordance with examples as disclosed herein. In some implementations, aspects of the operations of 1705 may be performed by a control messaging component 1025 as described with reference to FIG. 10.

At 1710, the method may include transmitting, during a COT obtained via a first channel access type, a first uplink message within a threshold COT associated with the first uplink message, where the COT is released after the first uplink message. The operations of 1710 may be performed in accordance with examples as disclosed herein. In some implementations, aspects of the operations of 1710 may be performed by an uplink transmission component 1035 as described with reference to FIG. 10.

At 1715, the method may include transmitting, during a resumption of the COT and based on whether a second channel access type is present in the set of one or more channel access types, a second uplink message in accordance with the second channel access type, where the second channel access type is different from the first channel access type. The operations of 1715 may be performed in accordance with examples as disclosed herein. In some implementations, aspects of the operations of 1715 may be performed by an uplink transmission component 1035 as described with reference to FIG. 10.

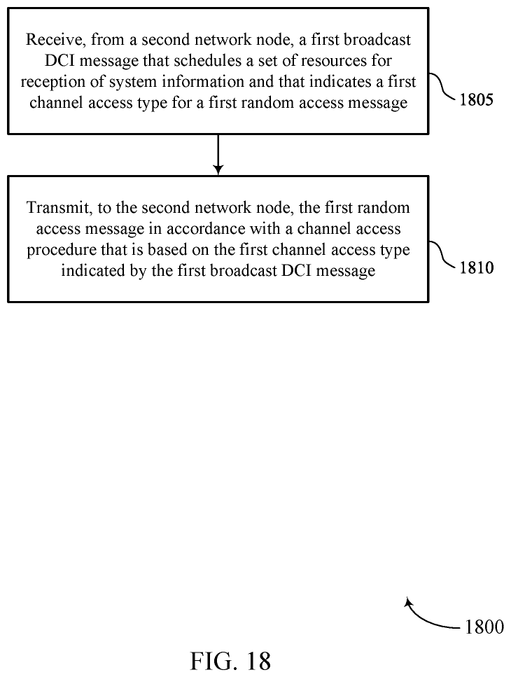

FIG. 18 shows a flowchart illustrating a method 1800 that supports control mechanisms for uplink channel access types in accordance with one or more aspects of the present disclosure. The operations of the method 1800 may be implemented by a UE or its components as described herein. For example, the operations of the method 1800 may be performed by a UE 115 as described with reference to FIGS. 1 through 11. In some implementations, a UE may execute a set of instructions to control the functional elements of the UE to perform the described functions. Additionally, or alternatively, the UE may perform aspects of the described functions using special-purpose hardware.

At 1805, the method may include receiving, from a second network node, a first broadcast DCI message that schedules a set of resources for reception of system information and that indicates a first channel access type for a first random access message. The operations of 1805 may be performed in accordance with examples as disclosed herein. In some implementations, aspects of the operations of 1805 may be performed by a DCI component 1030 as described with reference to FIG. 10.

At 1810, the method may include transmitting, to the second network node, the first random access message in accordance with a channel access procedure that is based on the first channel access type indicated by the first broadcast DCI message. The operations of 1810 may be performed in accordance with examples as disclosed herein. In some implementations, aspects of the operations of 1810 may be performed by a random access messaging component 1040 as described with reference to FIG. 10.

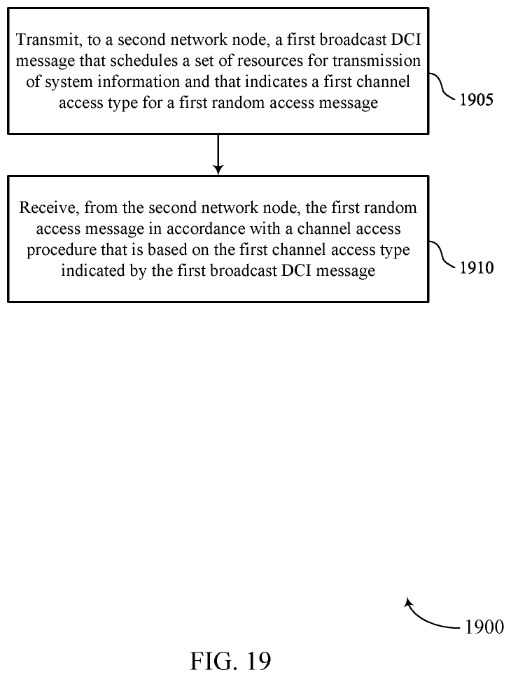

FIG. 19 shows a flowchart illustrating a method 1900 that supports control mechanisms for uplink channel access types in accordance with one or more aspects of the present disclosure. The operations of the method 1900 may be implemented by a network entity or its components as described herein. For example, the operations of the method 1900 may be performed by a network entity as described with reference to FIGS. 1 through 7 and 12 through 15. In some implementations, a network entity may execute a set of instructions to control the functional elements of the network entity to perform the described functions. Additionally, or alternatively, the network entity may perform aspects of the described functions using special-purpose hardware.

At 1905, the method may include transmitting, to a second network node, a first broadcast DCI message that schedules a set of resources for transmission of system information and that indicates a first channel access type for a first random access message. The operations of 1905 may be performed in accordance with examples as disclosed herein. In some implementations, aspects of the operations of 1905 may be performed by a DCI component 1425 as described with reference to FIG. 14.

At 1910, the method may include receiving, from the second network node, the first random access message in accordance with a channel access procedure that is based on the first channel access type indicated by the first broadcast DCI message. The operations of 1910 may be performed in accordance with examples as disclosed herein. In some implementations, aspects of the operations of 1910 may be performed by a random access messaging component 1430 as described with reference to FIG. 14.

The following provides an overview of aspects of the present disclosure:
Aspect 1: A method of wireless communication performed by a first network node, comprising: receiving, from a second network node, a control message that indicates a set of one or more channel access types that are available to the first network node for communications between the first network node and the second network node; receiving, from the second network node, a first DCI message that schedules an uplink message from the first network node and indicates, for the uplink message, a first channel access type from the set of one or more channel access types; and transmitting, during a COT of the second network node and based on whether a second channel access type is present in the set of one or more channel access types indicated by the control message, the uplink message in accordance with the second channel access type, wherein the second channel access type is different from the first channel access type.
Aspect 2: The method of aspect 1, wherein the set of one or more channel access types that are available to the first network node includes the first channel access type and at least one of a first candidate channel access type or a second candidate channel access type; and the second channel access type is one of the first candidate channel access type or the second candidate channel access type.
Aspect 3: The method of aspect 2, wherein transmitting the uplink message in accordance with the second channel access type comprises: transmitting the uplink message during the COT of the second network node in accordance with the first candidate channel access type based on the first candidate channel access type being present in the set of one or more channel access types or based on the second candidate channel access type being excluded from the set of one or more channel access types.
Aspect 4: The method of aspect 2, wherein transmitting the uplink message in accordance with the second channel access type comprises: transmitting the uplink message during the COT of the second network node in accordance with the second candidate channel access type based on the second candidate channel access type being present in the set of one or more channel access types or based on the first candidate channel access type being excluded from the set of one or more channel access types.
Aspect 5: The method of any of aspects 2 through 4, wherein the first channel access type includes one or more channel sensing operations associated with a channel sensing count prior to occupation of a channel between the first network node and the second network node; and the first candidate channel access type includes a single channel sensing operation prior to occupation of the channel; and the second candidate channel access type excludes channel sensing operations prior to occupation of the channel.
Aspect 6: The method of aspect 5, wherein each respective channel sensing operation is a respective LBT operation.
Aspect 7: The method of any of aspects 1 through 6, wherein the control message indicates a mapping between each respective permutation of a plurality of permutations of a set of one or more bits and each respective channel access type of the set of one or more channel access types.
Aspect 8: The method of aspect 7, wherein the first DCI message includes a first permutation of the plurality of permutations of the set of one or more bits, and the first permutation maps to the first channel access type in accordance with the mapping.
Aspect 9: The method of aspect 8, wherein the first DCI message includes a channel access control field including the first permutation.
Aspect 10: The method of any of aspects 7 through 9, wherein the second channel access type is present in the set of one or more channel access types if at least one permutation of the plurality of permutations maps to the second channel access type in accordance with the mapping.
Aspect 11: The method of any of aspects 1 through 6, wherein the control message indicates a first mapping between each respective permutation of a plurality of permutations of a set of one or more bits and each respective channel access type of a first set of one or more channel access types; and the control message indicates a second mapping between each respective permutation of the plurality of permutations of the set of one or more bits and each respective channel access type of a second set of one or more channel access types; and the set of one or more channel access types comprises the first set of one or more channel access types and the second set of one or more channel access types.
Aspect 12: The method of aspect 11, wherein the first DCI message includes a first permutation of the plurality of permutations of the set of one or more bits, and the first permutation maps to the first channel access type in accordance with the first mapping.
Aspect 13: The method of aspect 12, wherein the first DCI message includes a channel access control field including the first permutation.
Aspect 14: The method of any of aspects 11 through 13, wherein the first mapping is associated with DCI messages that schedule uplink communication; and the second mapping is associated with DCI messages that schedule downlink communication.
Aspect 15: The method of any of aspects 11 through 14, wherein the second channel access type is present in the set of one or more channel access types if at least one permutation of the plurality of permutations maps to the second channel access type in accordance with the first mapping or the second mapping.
Aspect 16: The method of any of aspects 11 through 15, wherein the second channel access type is present in the set of one or more channel access types if at least one first permutation of the plurality of permutations maps to the second channel access type in accordance with the first mapping and at least one second permutation of the plurality of permutations maps to the second channel access type in accordance with the second mapping.
Aspect 17: The method of any of aspects 11 through 16, wherein the second channel access type is present in the set of one or more channel access types if at least one permutation of the plurality of permutations maps to the second channel access type in accordance with the first mapping.
Aspect 18: The method of any of aspects 11 through 17, wherein the second channel access type is present in the set of one or more channel access types if at least one permutation of the plurality of permutations maps to the second channel access type in accordance with the second mapping.
Aspect 19: The method of any of aspects 1 through 18, further comprising: receiving, from the second network node, a second DCI message that indicates a slot format, wherein the slot format indicates the COT of the second network node, and wherein the uplink message is transmitted in accordance with the second channel access type based on the slot format.
Aspect 20: The method of aspect 19, wherein the slot format indicates a starting time and a duration of the COT of the second network node.
Aspect 21: The method of any of aspects 1 through 20, wherein the control message that indicates the set of one or more channel access types enables or disables an upgrade, for the uplink message, from the first channel access type to the second channel access type during the COT of the second network node based on whether the second channel access type is present in the set of one or more channel access types.
Aspect 22: The method of any of aspects 1 through 21, wherein a presence of the second channel access type in the set of one or more channel access types is based on a geographic location of the first network node.
Aspect 23: A method of wireless communication performed by first network node, comprising: receiving, from a second network node, a control message that indicates a set of one or more channel access types that are available to the first network node for communications between the first network node and the second network node; transmitting, during a COT obtained via a first channel access type, a first uplink message within a threshold COT associated with the first uplink message, wherein the COT is released after the first uplink message; and transmitting, during a resumption of the COT and based on whether a second channel access type is present in the set of one or more channel access types, a second uplink message in accordance with the second channel access type, wherein the second channel access type is different from the first channel access type.
Aspect 24: The method of aspect 23, wherein the set of one or more channel access types that are available to the first network node includes the first channel access type and at least one of a first candidate channel access type or a second candidate channel access type; and the second channel access type is one of the first candidate channel access type or the second candidate channel access type.
Aspect 25: The method of aspect 24, wherein transmitting the second uplink message in accordance with the second channel access type comprises: transmitting the second uplink message during the resumption of the COT in accordance with the first candidate channel access type based on the first candidate channel access type being present in the set of one or more channel access types or based on the second candidate channel access type being excluded from the set of one or more channel access types.
Aspect 26: The method of aspect 24, wherein transmitting the second uplink message in accordance with the second channel access type comprises: transmitting the second uplink message during the resumption of the COT in accordance with the second candidate channel access type based on the second candidate channel access type being present in the set of one or more channel access types or based on the first candidate channel access type being excluded from the set of one or more channel access types.
Aspect 27: The method of any of aspects 24 through 26, wherein the first channel access type includes one or more channel sensing operations associated with a channel sensing count prior to occupation of a channel between the first network node and the second network node; and the first candidate channel access type includes a single channel sensing operation prior to occupation of the channel; and the second candidate channel access type excludes channel sensing operations prior to occupation of the channel.
Aspect 28: The method of aspect 27, wherein each respective channel sensing operation is a respective LBT operation.
Aspect 29: The method of any of aspects 23 through 28, wherein the control message indicates a mapping between each respective permutation of a plurality of permutations of a set of one or more bits and each respective channel access type of the set of one or more channel access types.
Aspect 30: The method of aspect 29, wherein a DCI message that schedules the first uplink message includes a first permutation of the plurality of permutations of the set of one or more bits, and the first permutation maps to the first channel access type in accordance with the mapping.
Aspect 31: The method of aspect 30, wherein the DCI message includes a channel access control field including the first permutation.
Aspect 32: The method of any of aspects 29 through 31, wherein the second channel access type is present in the set of one or more channel access types if at least one permutation of the plurality of permutations maps to the second channel access type in accordance with the mapping.
Aspect 33: The method of any of aspects 23 through 28, wherein the control message indicates a first mapping between each respective permutation of a plurality of permutations of a set of one or more bits and each respective channel access type of a first set of one or more channel access types; and the control message indicates a second mapping between each respective permutation of the plurality of permutations of the set of one or more bits and each respective channel access type of a second set of one or more channel access types; and the set of one or more channel access types comprises the first set of one or more channel access types and the second set of one or more channel access types.
Aspect 34: The method of aspect 33, wherein a DCI message that schedules the first uplink message includes a first permutation of the plurality of permutations of the set of one or more bits, and the first permutation maps to the first channel access type in accordance with the first mapping.
Aspect 35: The method of aspect 34, wherein the DCI message includes a channel access control field including the first permutation.
Aspect 36: The method of any of aspects 33 through 35, wherein the first mapping is associated with DCI messages that schedule uplink communication; and the second mapping is associated with DCI messages that schedule downlink communication.
Aspect 37: The method of any of aspects 33 through 36, wherein the second channel access type is present in the set of one or more channel access types if at least one permutation of the plurality of permutations maps to the second channel access type in accordance with the first mapping or the second mapping.
Aspect 38: The method of any of aspects 33 through 37, wherein the second channel access type is present in the set of one or more channel access types if at least one first permutation of the plurality of permutations maps to the second channel access type in accordance with the first mapping and at least one second permutation of the plurality of permutations maps to the second channel access type in accordance with the second mapping.
Aspect 39: The method of any of aspects 33 through 38, wherein the second channel access type is present in the set of one or more channel access types if at least one permutation of the plurality of permutations maps to the second channel access type in accordance with the first mapping.
Aspect 40: The method of any of aspects 33 through 39, wherein the second channel access type is present in the set of one or more channel access types if at least one permutation of the plurality of permutations maps to the second channel access type in accordance with the second mapping.
Aspect 41: The method of any of aspects 23 through 40, further comprising: resuming the COT for the second uplink message in accordance with the second channel access type based on whether the second channel access type is present in the set of one or more channel access types, wherein the second uplink message is transmitted based on the resumption of the COT in accordance with the second channel access type.
Aspect 42: The method of any of aspects 23 through 41, wherein the control message that indicates the set of one or more channel access types enables or disables an upgrade, for the second uplink message, from the first channel access type to the second channel access type during the resumption of the COT based on whether the second channel access type is present in the set of one or more channel access types.
Aspect 43: The method of any of aspects 23 through 42, wherein a presence of the second channel access type in the set of one or more channel access types is based on a geographic location of the first network node.
Aspect 44: A method of wireless communication performed by a first network node, comprising: receiving, from a second network node, a first broadcast DCI message that schedules a set of resources for reception of system information and that indicates a first channel access type for a first random access message; and transmitting, to the second network node, the first random access message in accordance with a channel access procedure that is based on the first channel access type indicated by the first broadcast DCI message.
Aspect 45: The method of aspect 44, further comprising: receiving information indicative of the first channel access type via a channel access control field of the first broadcast DCI message.
Aspect 46: The method of any of aspects 44 or 45, wherein the first channel access type indicates that the first network node is to skip a LBT procedure for the first random access message or that the first network node is to perform the LBT procedure for the first random access message.
Aspect 47: The method of any of aspects 44 through 46, wherein the first channel access type indicates one of a first candidate channel access type or a second candidate channel access type; and the first candidate channel access type includes one or more channel sensing operations during a pendency of a countdown timer prior to occupation of a channel between the first network node and the second network node; and the second candidate channel access type excludes channel sensing operations prior to occupation of a channel between the first network node and the second network node.
Aspect 48: The method of aspect 47, wherein transmitting the first random access message comprises: transmitting the first random access message via contention-based signaling if the first network node is to use the first candidate channel access type for the first random access message; or transmitting the first random access message via contention-exempt signaling if the first network node is to use the second candidate channel access type for the first random access message.
Aspect 49: The method of any of aspects 44 through 48, further comprising: decoding the first broadcast DCI message based on a system information radio network identifier.
Aspect 50: The method of any of aspects 44 through 49, further comprising: receiving a second broadcast DCI that indicates a second channel access type for the first random access message, wherein the second channel access type is different from the first channel access type; and ignoring the second channel access type for the first random access message in accordance with a configured rule.
Aspect 51: The method of aspect 50, wherein the configured rule indicates that the second channel access type is to be ignored if the first channel access type is indicated for the first random access message.
Aspect 52: The method of aspect 51, wherein the configured rule indicates that the second channel access type is to be ignored if the first channel access type includes one or more channel sensing operations associated with a channel sensing count prior to occupation of a channel between the first network node and the second network node.
Aspect 53: The method of aspect 51, wherein the configured rule indicates that the second channel access type is to be ignored if the first channel access type excludes channel sensing operations prior to occupation of a channel between the first network node and the second network node.
Aspect 54: The method of any of aspects 44 through 53, wherein the first broadcast DCI message that indicates the first channel access type for the first random access message enables or disables an upgrade, for the first random access message, from contention-based signaling to contention-exempt signaling based on the first channel access type.
Aspect 55: The method of any of aspects 44 through 54, further comprising: receive, from the second network node, a second random access message responsive to the first random access message; and establish a connection between the first network node and the second network node based on the first random access message and the second random access message.
Aspect 56: The method of any of aspects 44 through 55, wherein the first channel access type is based on a geographic location of the first network node.
Aspect 57: A method of wireless communication performed by a first network node, comprising: transmitting, to a second network node, a first broadcast DCI message that schedules a set of resources for transmission of system information and that indicates a first channel access type for a first random access message; and receiving, from the second network node, the first random access message in accordance with a channel access procedure that is based on the first channel access type indicated by the first broadcast DCI message.
Aspect 58: The method of aspect 57, further comprising: transmitting information indicative of the first channel access type via a channel access control field of the first broadcast DCI message.
Aspect 59: The method of any of aspects 57 through 58, wherein the first channel access type indicates that the second network node is to skip an LBT procedure for the first random access message or that the second network node is to perform the LBT procedure for the first random access message.
Aspect 60: The method of any of aspects 57 through 59, wherein the first channel access type indicates one of a first candidate channel access type or a second candidate channel access type; and the first candidate channel access type includes one or more channel sensing operations during a pendency of a countdown timer prior to occupation of a channel between the first network node and the second network node; and the second candidate channel access type excludes channel sensing operations prior to occupation of a channel between the first network node and the second network node.
Aspect 61: The method of aspect 60, wherein receiving the first random access message comprises: receiving the first random access message via contention-based signaling if the second network node is to use the first candidate channel access type for the first random access message; or receiving the first random access message via contention-exempt signaling if the second network node is to use the second candidate channel access type for the first random access message.
Aspect 62: The method of any of aspects 57 through 61, further comprising: scrambling the first broadcast DCI message based on a system information radio network identifier.
Aspect 63: The method of any of aspects 57 through 62, further comprising: transmitting a second broadcast DCI that indicates a second channel access type for the first random access message, wherein the second channel access type is different from the first channel access type; and ignoring the second channel access type for the first random access message in accordance with a configured rule.
Aspect 64: The method of aspect 63, wherein the configured rule indicates that the second channel access type is to be ignored if the first channel access type is indicated for the first random access message.
Aspect 65: The method of aspect 64, wherein the configured rule indicates that the second channel access type is to be ignored if the first channel access type includes one or more channel sensing operations associated with a channel sensing count prior to occupation of a channel between the first network node and the second network node.
Aspect 66: The method of aspect 64, wherein the configured rule indicates that the second channel access type is to be ignored if the first channel access type excludes channel sensing operations prior to occupation of a channel between the first network node and the second network node.
Aspect 67: The method of any of aspects 57 through 66, wherein the first broadcast DCI message that indicates the first channel access type for the first random access message enables or disables an upgrade, for the first random access message, from contention-based signaling to contention-exempt signaling based on the first channel access type.
Aspect 68: The method of any of aspects 57 through 67, further comprising: transmitting, to the second network node, a second random access message responsive to the first random access message; and establishing a connection between the first network node and the second network node based on the first random access message and the second random access message.
Aspect 69: The method of any of aspects 57 through 68, wherein the first channel access type is based on a geographic location of the first network node.
Aspect 70: A first network node for wireless communication, comprising a memory; and at least one processor coupled to the memory, wherein the at least one processor is configured to perform a method of any of aspects 1 through 22.
Aspect 71: An apparatus for wireless communication at a first network node, comprising at least one means for performing a method of any of aspects 1 through 22.
Aspect 72: A non-transitory computer-readable medium having code for wireless communication stored thereon that, when executed by a first network node, causes the first network node to perform a method of any of aspects 1 through 22.
Aspect 73: A first network node for wireless communication, comprising a memory; and at least one processor coupled to the memory, wherein the at least one processor is configured to perform a method of any of aspects 23 through 43.
Aspect 74: An apparatus for wireless communication at first network node, comprising at least one means for performing a method of any of aspects 23 through 43.
Aspect 75: A non-transitory computer-readable medium having code for wireless communication stored thereon that, when executed by a first network node, causes the first network node to perform a method of any of aspects 23 through 43.
Aspect 76: A first network node for wireless communication, comprising a memory; and at least one processor coupled to the memory, wherein the at least one processor is configured to perform a method of any of aspects 44 through 56.
Aspect 77: An apparatus for wireless communication at a first network node, comprising at least one means for performing a method of any of aspects 44 through 56.
Aspect 78: A non-transitory computer-readable medium having code for wireless communication stored thereon that, when executed by a first network node, causes the first network node to perform a method of any of aspects 44 through 56.
Aspect 79: A first network node for wireless communication, comprising a memory; and at least one processor coupled to the memory, wherein the at least one processor is configured to perform a method of any of aspects 57 through 69.
Aspect 80: An apparatus for wireless communication at a first network node, comprising at least one means for performing a method of any of aspects 57 through 69.
Aspect 81: A non-transitory computer-readable medium having code for wireless communication stored thereon that, when executed by a first network node, causes the first network node to perform a method of any of aspects 57 through 69.

The methods described herein describe possible implementations, and the operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor also may be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions also may be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The term “determine” or “determining” encompasses a variety of actions and, therefore, “determining” can include calculating, computing, processing, deriving, investigating, looking up (e.g., via looking up in a table, a database or another data structure), ascertaining and the like. Also, “determining” can include receiving (e.g., receiving information), accessing (e.g., accessing data in a memory) and the like. Also, “determining” can include resolving, obtaining, selecting, choosing, establishing and other such similar actions.

In the drawings, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration,” and not “preferred” or “advantageous over other aspects.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network node for wireless communication, comprising:
a memory; and
at least one processor coupled to the memory, wherein the at least one processor is configured to:
receive, from a second network node, a control message that indicates a set of one or more channel access types that are available to the first network node for communications between the first network node and the second network node;
receive, from the second network node, a first downlink control information message that schedules an uplink message from the first network node and indicates, for the uplink message, a first channel access type from the set of one or more channel access types; and
transmit, during a channel occupancy time of the second network node and based on whether a second channel access type is present in the set of one or more channel access types indicated by the control message, the uplink message in accordance with the second channel access type, wherein the second channel access type is different from the first channel access type.

2. The first network node of claim 1, wherein the set of one or more channel access types that are available to the first network node includes the first channel access type and at least one of a first candidate channel access type or a second candidate channel access type, and wherein the second channel access type is one of the first candidate channel access type or the second candidate channel access type.

3. The first network node of claim 2, wherein, to transmit the uplink message in accordance with the second channel access type, the at least one processor is configured to:
transmit the uplink message during the channel occupancy time of the second network node in accordance with the first candidate channel access type based on the first candidate channel access type being present in the set of one or more channel access types or based on the second candidate channel access type being excluded from the set of one or more channel access types.

4. The first network node of claim 2, wherein, to transmit the uplink message in accordance with the second channel access type, the at least one processor is configured to:
transmit the uplink message during the channel occupancy time of the second network node in accordance with the second candidate channel access type based on the second candidate channel access type being present in the set of one or more channel access types or based on the first candidate channel access type being excluded from the set of one or more channel access types.

5. The first network node of claim 2, wherein the first channel access type includes one or more channel sensing operations associated with a channel sensing count prior to occupation of a channel between the first network node and the second network node, and wherein the first candidate channel access type includes a single channel sensing operation prior to occupation of the channel, and wherein the second candidate channel access type excludes channel sensing operations prior to occupation of the channel.

6. The first network node of claim 1, wherein the control message indicates a mapping between each respective permutation of a plurality of permutations of a set of one or more bits and each respective channel access type of the set of one or more channel access types.

7. The first network node of claim 6, wherein the first downlink control information message includes a channel access control field including a first permutation of the plurality of permutations of the set of one or more bits, and wherein the first permutation maps to the first channel access type in accordance with the mapping.

8. The first network node of claim 6, wherein the second channel access type is present in the set of one or more channel access types if at least one permutation of the plurality of permutations maps to the second channel access type in accordance with the mapping.

9. The first network node of claim 1, wherein the control message indicates a first mapping between each respective permutation of a plurality of permutations of a set of one or more bits and each respective channel access type of a first set of one or more channel access types, and wherein the control message indicates a second mapping between each respective permutation of the plurality of permutations of the set of one or more bits and each respective channel access type of a second set of one or more channel access types, and wherein the set of one or more channel access types comprises the first set of one or more channel access types and the second set of one or more channel access types.

10. The first network node of claim 9, wherein the first downlink control information message includes a channel access control field including a first permutation of the plurality of permutations of the set of one or more bits, and wherein the first permutation maps to the first channel access type in accordance with the first mapping.

11. The first network node of claim 9, wherein the first mapping is associated with downlink control information messages that schedule uplink communication, and wherein the second mapping is associated with downlink control information messages that schedule downlink communication.

12. The first network node of claim 9, wherein the second channel access type is present in the set of one or more channel access types if at least one permutation of the plurality of permutations maps to the second channel access type in accordance with the first mapping or the second mapping.

13. The first network node of claim 9, wherein the second channel access type is present in the set of one or more channel access types if at least one first permutation of the plurality of permutations maps to the second channel access type in accordance with the first mapping and at least one second permutation of the plurality of permutations maps to the second channel access type in accordance with the second mapping.

14. The first network node of claim 9, wherein the second channel access type is present in the set of one or more channel access types if at least one permutation of the plurality of permutations maps to the second channel access type in accordance with the first mapping.

15. The first network node of claim 9, wherein the second channel access type is present in the set of one or more channel access types if at least one permutation of the plurality of permutations maps to the second channel access type in accordance with the second mapping.

16. The first network node of claim 1, wherein the at least one processor is further configured to:
receive, from the second network node, a second downlink control information message that indicates a slot format, wherein the slot format indicates a starting time and a duration of the channel occupancy time of the second network node, and wherein the uplink message is transmitted in accordance with the second channel access type based on the slot format.

17. The first network node of claim 1, wherein the control message that indicates the set of one or more channel access types enables or disables an upgrade, for the uplink message, from the first channel access type to the second channel access type during the channel occupancy time of the second network node based on whether the second channel access type is present in the set of one or more channel access types.

18. The first network node of claim 1, wherein a presence of the second channel access type in the set of one or more channel access types is based on a geographic location of the first network node.

19. A first network node for wireless communication, comprising:
a memory; and
at least one processor coupled to the memory, wherein the at least one processor is configured to:
receive, from a second network node, a control message that indicates a set of one or more channel access types that are available to the first network node for communications between the first network node and the second network node;
transmit, during a channel occupancy time obtained via a first channel access type, a first uplink message within a threshold channel occupancy time associated with the first uplink message, wherein the channel occupancy time is released after the first uplink message; and
transmit, during a resumption of the channel occupancy time and based on whether a second channel access type is present in the set of one or more channel access types, a second uplink message in accordance with the second channel access type, wherein the second channel access type is different from the first channel access type.

20. The first network node of claim 19, wherein the set of one or more channel access types that are available to the first network node includes the first channel access type and at least one of a first candidate channel access type or a second candidate channel access type, wherein the second channel access type is one of the first candidate channel access type or the second candidate channel access type.

21. The first network node of claim 20, wherein, to transmit the second uplink message in accordance with the second channel access type, the at least one processor is configured to:
transmit the second uplink message during the resumption of the channel occupancy time in accordance with the first candidate channel access type based on the first candidate channel access type being present in the set of one or more channel access types or based on the second candidate channel access type being excluded from the set of one or more channel access types.

22. The first network node of claim 20, wherein, to transmit the second uplink message in accordance with the second channel access type, the at least one processor is configured to:
transmit the second uplink message during the resumption of the channel occupancy time in accordance with the second candidate channel access type based on the second candidate channel access type being present in the set of one or more channel access types or based on the first candidate channel access type being excluded from the set of one or more channel access types.

23. The first network node of claim 20, wherein the first channel access type includes one or more channel sensing operations associated with a channel sensing count prior to occupation of a channel between the first network node and the second network node, and wherein the first candidate channel access type includes a single channel sensing operation prior to occupation of the channel, and wherein the second candidate channel access type excludes channel sensing operations prior to occupation of the channel.

24. The first network node of claim 19, wherein the control message indicates a mapping between each respective permutation of a plurality of permutations of a set of one or more bits and each respective channel access type of the set of one or more channel access types.

25. The first network node of claim 24, wherein a downlink control information message that schedules the first uplink message includes a channel access control field including a first permutation of the plurality of permutations of the set of one or more bits, and wherein the first permutation maps to the first channel access type in accordance with the mapping.

26. The first network node of claim 24, wherein the second channel access type is present in the set of one or more channel access types if at least one permutation of the plurality of permutations maps to the second channel access type in accordance with the mapping.

27. The first network node of claim 19, wherein the control message indicates a first mapping between each respective permutation of a plurality of permutations of a set of one or more bits and each respective channel access type of a first set of one or more channel access types, and wherein the control message indicates a second mapping between each respective permutation of the plurality of permutations of the set of one or more bits and each respective channel access type of a second set of one or more channel access types, and wherein the set of one or more channel access types comprises the first set of one or more channel access types and the second set of one or more channel access types.

28. The first network node of claim 27, wherein a downlink control information message that schedules the first uplink message includes a channel access control field including a first permutation of the plurality of permutations of the set of one or more bits, and wherein the first permutation maps to the first channel access type in accordance with the first mapping.

29. A method of wireless communication performed by a first network node, comprising:
receiving, from a second network node, a control message that indicates a set of one or more channel access types that are available to the first network node for communications between the first network node and the second network node;
receiving, from the second network node, a first downlink control information message that schedules an uplink message from the first network node and indicates, for the uplink message, a first channel access type from the set of one or more channel access types; and
transmitting, during a channel occupancy time of the second network node and based on whether a second channel access type is present in the set of one or more channel access types indicated by the control message, the uplink message in accordance with the second channel access type, wherein the second channel access type is different from the first channel access type.

30. A method of wireless communication performed by a first network node, comprising:
receiving, from a second network node, a control message that indicates a set of one or more channel access types that are available to the first network node for communications between the first network node and the second network node;
transmitting, during a channel occupancy time obtained via a first channel access type, a first uplink message within a threshold channel occupancy time associated with the first uplink message, wherein the channel occupancy time is released after the first uplink message; and
transmitting, during a resumption of the channel occupancy time and based on whether a second channel access type is present in the set of one or more channel access types, a second uplink message in accordance with the second channel access type, wherein the second channel access type is different from the first channel access type.
